(19) United States
(12) Patent Application Publication
(10) Pub. No.: US 2026/0284650 A1
(43) Pub. Date: Sep. 24, 2026

(54) CONDUCTIVE OR SEMI-CONDUCTIVE CLUSTERS PRODUCED VIA SPARK ABLATION

(71) Applicants: ECOLE POLYTECHNIQUE FEDERALE DE LAUSANNE (EPFL), Lausanne (CH); EMPA EIDGENÕSSISCHE MATERIALPRÜFUNGS- UND FORSCHUNGSANSTALT, Dübendorf (CH)

(72) Inventors: Cedric David KOOLEN, Sion (CH); Andreas ZUETTEL, Sion (CH)

(73) Assignees: ECOLE POLYTECHNIQUE FEDERALE DE LAUSANNE (EPFL), Lausanne (CH); EMPA EIDGENÕSSISCHE MATERIALPRÜFUNGS- UND FORSCHUNGSANSTALT, Dübendorf (CH)

(21) Appl. No.: 19/472,405

(22) PCT Filed: Apr. 2, 2024
(86) PCT No.: PCT/EP2024/058885

§ 371 Date: Oct. 3, 2025

(30) Foreign Application Priority Data
Apr. 6, 2023 (EP) 23167026.6

(51) Int. Cl. B01J 37/34; B01J 35/30

(52) U.S. Cl. CPC B01J 37/349; B01J 35/392; B01J 35/394; B01J 37/347

(57) ABSTRACT

A conductive or semi-conductive cluster essentially comprises or consists of a first-type material, wherein the first-type material comprises a number of surface atoms that is at least half of a number of total atoms of the first-type material, and wherein the cluster comprises less than 100 ppm of a second-type material being different from the first-type material. The cluster is produced via spark ablation.

### TECHNICAL FIELD

The present invention relates to a conductive or semi-conductive cluster as claimed in claim 1, to a method of producing such as cluster as claimed in claim 4, to the use of such a cluster as catalyst, as indicator or as conductor as claimed in claim 7, to an assembly comprising such a cluster being immobilized on a support as claimed in claim 8, to a method of producing such an assembly as claimed in claim 11, to the use of such an assembly as a catalyst as claimed in claim 14, and to a method of catalytically converting reactants using such an assembly as claimed in claim 15.

### PRIOR ART

The electrification of the chemical industry is needed for a complete and unambiguous energy transition.¹ Many processes depend heavily on the petrochemical industry, which are neither green nor energy efficient. One such processes is the well-known homogeneously catalyzed production of the base chemical acetaldehyde, used in the production of drugs, dyes, and fragrances.² Commercialized under the name of the Wacker process, the PdII catalyzed oxidation of ethylene to acetaldehyde supplies the vast majority of the global acetaldehyde market worth well over 1.2B USD.^{3,4,5} This process not only uses a cracking product, ethylene, it requires large amounts of hydrochloric acid to achieve required conversions.^{4,5} Although reliable, overcoming the limitations of this resource an energy intensive process is needed for a sustainable supply in the long term. Attempts have been made to heterogeneously convert ethylene to acetaldehyde using Pd—Cu zeolite catalysts fixing the acid sites on the support significantly reducing the environmental toll of the process.⁶ However, such methods still rely on the petrochemically sourced ethylene and selectivity's are not yet at par.

The electrochemical CO₂ reduction reaction (CO2RR) is a promising technology of industrial relevance that kills two birds with one stone: 1) it has the ability to significantly reduce our CO₂ footprint by fixating it in useful products and 2) it tackles the intermittence problem associated with renewable energy as it offers to store energy long-term in chemical bonds.⁷ However, it comes with significant challenges.⁸ In particular, the more valuable products that require carbon-carbon coupling such as ethanol, ethylene and acetaldehyde can only be produced on Cu.⁹ Moreover, polycrystalline Cu catalyzes the reaction of no less than 16 individual products resulting in low selectivity's for specific products and thus large energy losses.¹⁰ Previous works have shown that on bulk Cu specific active sites have activities for specific products, i.e. Cu(111) surfaces produce majority CH₄, Cu(100) majority ethylene and Cu(110) majority oxygenates including ethanol.^{11,12,13,14} Further, defects, steps, kinks- and edge-sites have also been shown to show preferentiality towards specific pathways.^{15,16,17} Therefore, tremendous efforts have gone out to engineer Cu electrodes to expose those facets, defects and or sites to produce specific products with unitary selectivity's.^{16,19,20,21,22} Also, attempts have been made to mix in other elements in the form of homogeneous Cu alloys and change the catalyst electronic nature.^{23,24,25,26} Unfortunately, for any of these attempts, selectivity's>50% have seldomly been reported.^{20,26}

Recently, Cu clusters<2 nm have been proposed as an opportunity to improve the definition of the catalyst active site²⁷ and has successfully enhanced the selectivity towards ethanol to industrial relevance (>90%).^{28,29,30}

### SUMMARY OF THE INVENTION

It is an object of the present invention to provide a cluster and a method of producing a cluster that overcomes the drawbacks of the prior art. In particular, it is an object to provide a cluster of high purity that can be produced in a simple manner.

In a first aspect, a conductive or semi-conductive cluster is provided, wherein the cluster essentially comprises or consists of a first-type material. The first-type material comprises a number of surface atoms that is at least half of a number of total atoms of the first-type material. The cluster comprises less than 100 ppm of a second-type material being different from the first-type material.

The cluster essentially comprising or consisting of the first-type material means that the cluster preferably comprises less than 100 ppm, more preferably less than 10 ppm of the second-type material as determined via i.e. matrix-assisted laser desorption/ionization mass spectrometry, inductively coupled plasma mass spectrometry, energy dispersive x-ray spectroscopy, nuclear magnetic resonance spectroscopy, Fourier transform infrared spectroscopy, and CHNSO analysis.

That is, the cluster according to the invention can be seen as having a high purity. As will be explained in greater detail below, this is a result of the production of the cluster according to the invention via spark ablation. Namely, in contrast to cluster productions known in the state of the art, the spark ablation enables the cluster production without any ligands, surfactants, etc. In other words, the cluster according to the invention is preferably essentially free from materials, herein called second-type material, that typically occur in the productions of the prior art.

The second-type material preferably comprises or consists of inorganic compounds and/or organic compounds.

Additionally or alternatively, the second-type material preferably comprises or consists of salts, for instance halides such as fluorine (F⁻), chlorine (Cl⁻), bromine (Br⁻), or iodine (I⁻), nitrates such as NO₃⁻, sulfates such as SO₄⁻, phosphates such as PO₄³⁻ and PF₆⁻ or borates such as BO₃³⁻ and BF₄⁴.

Additionally or alternatively, the second-type material preferably comprises or consists of organic compounds comprising at least one carbon (C) atom and at least one hydrogen (H) atom. For instance, the second-type material can comprise or consist of acids such as citric acid, acetic acid, acetoacetic acid. Additionally or alternatively, the second-type material can comprise or consist of fatty acids such as lauric acid, stearic acid or oleic acid. Additionally or alternatively, the second-type material can comprise or consist of amines such as alkyl amines, for example octylamine, dodecylamine or oleylamine. Additionally or alternatively, the second-type material can comprise or consist of quartenary ammonium surfactants such as cetyltrimethylammonium, tetrabutylammonium, or dodecyltrimethylammonium. Additionally or alternatively, the second-type material can comprise or consist of thiols such as 1-hexadecanethiol, octadecanethiol or dodecanethiol. Additionally or alternatively, the second-type material can comprise or consist of phosphines such as triethylphosphine, triphenylphosphine, or trioctylphosphine. Additionally or alternatively, the second-type material can comprise or consist of phosphine oxides such as tributylphosphine oxide, trihexylphosphine oxide or trioctylphosphine oxide.

As is well-known in the art, surface atoms are those atoms of a cluster that are exposed at the surface of the cluster, whereas the core atoms are those atoms in the core of the cluster that are bonded to other cluster atoms and do not experience any influence from an environment of the cluster, e.g. gas, electrolyte, or a void in the case of the cluster being arranged under vacuum.

Hence, at least half of the total atoms that constitute the first-type material of the cluster are surface atoms. To this end it is conceivable that the first-type material consists of surface atoms, i.e. that it lacks any core atoms. However, it is likewise conceivable that the first-type material of the cluster comprises surface atoms as well as core atoms.

The first-type material preferably comprises core atoms, and wherein a ratio of the surface atoms to the core atoms is equal to or larger than 1.

For a given number of atoms, said surface atoms and core atoms can be arranged in space only in certain ways, which is dependent on the crystal structure or the phase, respectively, and the shape of the cluster. For example, Cu has a fcc crystal structure, Zn has an hop crystal structure and their oxides have i.e. monoclinic c2/c and P63mc space group crystal structures. The phase is a common term to describe the physical state of a solid, i.e. cubic phase, hexagonal phase etc. Therefore, given a specific shape and a given crystal structure or phase, a fixed number of surface atoms and core atoms and as such ratio exist.

The total number of atoms relates to the size of the cluster, therefore, the ratio between the surface atoms and the core atoms is size dependent. Consequently, the ratio of surface atoms to core atoms can be determined by measuring the size of the cluster.

The size of the cluster is preferably determined with transmission electron microscopy, for example with a Thermo Fischer TEM Talos, Titan Themis, Osiris, JEOL NEOARM, JEM-F200, JEM-ARM300F2.

Hence, given a known cluster size and the known phase (atomic mass), the number of atoms being comprised in the cluster can be calculated. Said calculation is well-known in the art, see for instance “The statistics of surface atoms and surface sites on metal crystals”, Surface Science, 1969, R. Van Hardeveld, F. Hartog, DOI:10.1016/0039-6028(69)90148-4.

Various ways of determining the phase (atomic mass) are well-known in the art as well, for instance via powder Xray diffraction, Xray photoemission spectroscopy, or electron diffraction.

Given any geometry such as spherical, octahedral, icosahedral, etc. and crystal structure such as hexagonal close-packed (hcp), face-centered cubic (fcc), and body-centered cubic (bcc) crystal structures, etc., clusters having a ratio of the surface atoms to the core atoms being equal or larger than 1, i.e. ≥1, exhibit quantization; in other words, such clusters exhibit a breakdown of their metallicity and scalability. In a sense, the energy levels of such clusters can be seen as no longer continuous but being discrete. It should be noted that the said ratio refers to the number of surface atoms to the number of core atoms, i.e. their actual count or atomicity.

In the following, an example for determining the ratio of the surface atoms to the core atoms is given for a Cu cluster of 1 nm in edge-length (corner to corner distance), which is assumed to be cubic. This is a volume of 1 nm3. The unit cell of a Cu crystal is 0.361 nm in length. Cu has an FCC crystal structure, and has therefore a cubic unit cell. Therefore, its volume=(0.361 nm)\hat{ }3. The cluster consists therefore of 1 nm3/(0.361 nm) \hat{ }3 unit cell. Each unit cell contains exactly 4 atoms. Therefore, the cluster contains (1 nm3/(0.361 nm) \hat{ }3)*4 atoms=85. This is the total number of atoms in the cluster, i.e. the cluster atomicity. The outer most shell of a cubic crystal consists of exactly one monolayer of atoms. The covalent radius of Cu=0.112 nm. Its diameter therefore is 0.224 nm and the thickness of the outermost layer 2D=0.448 nm. The volume of the core is than calculated as (edge-length-2D) \hat{ }3 and volume of the outermost layer=(edge−length) \hat{ }3−(edge−legnth−2D) \hat{ }3. Using the volume of the unit cell and the number of atoms per unit cell makes the total number of surface atoms=4*((edge−length) \hat{ }3−(edge−length−2D)\hat{ }3)/(length unit cell)\hat{ }3=70. Thereby, the number of core atoms is 15, and as a result, the ratio of the surface atoms to the core atoms is 4.67:1.

Additionally or alternatively, the ratio of the surface atoms to the core atoms can be determined from the density of the material and from its atomic mass. That is, the same calculation can be performed using the density of the first-type material and its atomic mass. If we consider the same cubic Cu cluster of 1 nm in edge-length, its volume is 1 nm³ or 10\hat{ }-27 m³. The density of Cu in the bulk is 8.95 g/cm³ or 8.95*10\hat{ }6 g/m³. This makes the mass of the cluster 8.95*10\hat{ }-21 g. And using the atomic mass of Cu, which is 63.456 Da, the number of moles of Cu can be calculated 8.95*10\hat{ }-21 g/63.456 g/mol=1.410*10\hat{ }-22 moles. And using Avogadro's number (6.022*10\hat{ }23) the number of Cu atoms can be calculated 1.410*10\hat{ }-22 moles*6.022*10\hat{ }23 molecules/mole=85. Using the covalent radius, and the monolayer approach disclosed previously, the ratio of the surface atoms to the core atoms can then again be determined and yields the same results, namely a ratio of the surface atoms to the core atoms of 4.67:1.

Additionally or alternatively, a total number of atoms being provided by the core atoms and the surface atoms (atomicity) is preferably smaller than 200 atoms, more preferably smaller than 150 atoms.

Additionally or alternatively, a size of the cluster is preferably smaller than 2 nanometers, more preferably smaller than 1 nanometer.

The atoms of the first-type material, in particular the core atoms and/or the surface atoms, are preferably transition metals, in particular noble transition metals and/or non-noble transition metals.

That is, the cluster according to the invention preferably is a metal cluster or a metal oxide cluster.

The first-type material of the cluster can comprise or consist of atoms, in particular of surface atoms and optionally furthermore of core atoms, of a single element, in particular of a single metal.

Likewise, the first-type material of the cluster can comprise or consist of atoms, in particular of surface atoms and optionally furthermore of core atoms, of two or more elements such as two or more metals i.e. the cluster can be bimetallic, trimetallic, etc.

That is, the first-type material of the cluster preferably comprises or consists of one or more metals, preferably one or more transition metals.

As an example, the first-type material of the cluster can comprise or consist of a non-noble transition metal such as copper (Cu). As another example, the first-type material of the cluster can comprise or consist of a noble transition metal such as silver (Ag). An example of a bimetallic cluster is a cluster comprising or consisting of a noble transition metal and of a non-noble transition metal such as of silver and copper (Ag—Cu).

However, various transition metals are conceivable, for instance nickel, iridium, cobalt, iron, ruthenium, nickel, platinum or gold.

It is furthermore preferred that the one or more metals, in particular the one or more transition metals, are provided in view of the final application of the cluster being used as catalyst. For instance, and as will be explained in greater detail below, the cluster is preferably used as a catalyst in an electrochemical reaction such as oxygen evolution, water splitting or CO₂ reduction to CO. When used as a catalyst for oxygen evolution, it is preferred that the clusters comprise or consist of iridium and/or cobalt and/or iron and/or ruthenium for oxygen evolution. When used as a catalyst for water splitting, it is preferred that the clusters comprise or consist of nickel and/or platinum. When used as a catalyst for CO₂ reduction to CO, it is preferred that the clusters comprise or consist of silver and/or gold.

In the event of the cluster being a metal oxide cluster, the cluster preferably comprises or consists of the said metal atoms as well as of oxygen atoms. Said metal oxides are preferably produced during the production of the cluster via the spark ablation. In fact, and as will be outlined in greater detail below, the spark ablation preferably makes use of a carrier gas, wherein said carrier gas is particularly preferably an inert gas such as Argon. Even in the event of high purity gas such as Ar 99.999% being used, the carrier gas typically still contains oxygen. And since the atoms upon spark ablation are highly reactive, they will become oxidized. However, pure metal clusters can be produced if the purity of the carrier gas is maintained, e.g. by using pure Ar or pure N2 (removing the oxygen in the gas prior to the spark ablation), and by preventing a presence of oxygen in other steps, e.g. if a sample transfer is done air free. In this case, the clusters can retain metallicity. Further, the proneness of the clusters to become oxidized also depends on the elements of the cluster, e.g. Pt may resist oxidation better than other metals. In the event of a pure carrier gas such as pure Ar or N2, metallic clusters are produced independently of their proneness to oxidize.

Alternatively, if a pure carrier gas cannot be maintained or if an oxidation takes place elsewhere in the production process, the metal oxide clusters can be reduced. For example, a reducing gas such as H2 can be introduced into the spark ablation device which reduces the clusters in the gas stream and have them be metallic.

It should be noted that oxygen-containing gases such as air or O2 may be additionally added to intentionally oxidize the metals. Those oxidized clusters, i.e. the metal oxide clusters, may be stable. As actually is the case for Cu and Ag. Only upon applying a negative potential do they become reduced. It would depend on the application if they stay oxidized or not. In other words, oxides of a metal oxide clusters can be removed, e.g. by subjecting the metal oxide clusters to a potential to become metallic, or alternatively be reduced with a reducing agent such as H2 gas.

Whether or not the metal oxides are reduced depends on the intended application of the clusters. For instance, in the event of an electrochemical CO2 reduction reaction, the clusters are preferably provided as metal clusters and the metal oxides are therefore preferably reduced prior to the reduction reaction, for instance in situ by applying a potential. However, there are many applications in which an oxide is the active catalysts so they need not be reduced per se. If the metal oxide clusters are used for an anodic reaction (positive potential), they must not be reduced but can stay in their oxidized state. If they are used for a cathodic reaction (negative potential), they may remain oxidized if the potential is not sufficiently negative to reduce them, etc.,

In another aspect, a method of producing a cluster as described above is provided, wherein the cluster is produced via spark ablation.

That is, the clusters according to the invention are produced via spark ablation and, consequently, are preferably produced with a spark ablation device. The spark ablation device preferably comprises components of spark ablation devices as they are well-known in the art. That is, the spark ablation device preferably comprises a spark chamber and a spark generator comprising at least two electrodes, at least one power source, and an RLC circuit (i.e. a circuit comprising a resistor, an inductor and a capacitor). Furthermore, a gas supply device is preferably present for supplying a carrier gas into the spark generator. The capacitor is preferably continually charged by the power source; when a breakdown voltage is reached, discharge occurs between the electrodes. The energy of the discharge is sufficient to cause an ablation of the electrodes. Electrode ablation is understood as the evaporation/vaporisation of the electrodes through the presence of a plasma. In particular, upon the breakdown of the potential, the carrier gas is ionized and becomes conductive, whereby a spark generated plasma, i.e. a plasma pulse is created that ablates the electrodes. In this way, an aerosol of clusters is produced.

Any statements made herein regarding the cluster as such preferably likewise apply to the method of producing the cluster and vice versa.

At least two electrodes are preferably ablated during the spark ablation. The electrodes can be the same or different from one another. Additionally or alternatively, the electrodes in each case preferably comprise or consist of at least one metal, in particular a transition metal. Additionally or alternatively, the electrodes in each case preferably comprise or consist of at least one conductive or semi-conductive material.

Electrodes being different from one another are electrodes comprising different materials, for instance different metals such as different transition metals, e.g. copper and silver. By selecting electrodes comprising different materials, clusters can thus be produced comprising a variety of materials. Electrodes being the same are electrodes comprising the same material, for instance copper.

It is preferred that the electrodes are hollow electrodes. In this case, the carrier gas can be supplied through the hollow electrodes.

Moreover, it is conceivable that a shape of the electrodes is the same or different from one another. For example, both electrodes can be hole electrodes. Likewise, one electrode can be a hollow electrode and the other electrode can be a pin electrode. Many other electrodes are of course likewise conceivable.

The electrodes are preferably electrically conducting or semi-conducting. Additionally or alternatively, the electrodes are preferably solid at room temperature.

The electrodes are preferably ablated via a spark generated plasma that is generated from a carrier gas. The carrier gas is preferably provided with a flow rate in the range of 10 lpm to 1000 lpm. Additionally or alternatively, the spark generated plasma preferably has an energy per spark in the range of 5 μJ to 400 μJ. Additionally or alternatively, the spark generated plasma preferably has a repetition frequency in the range of 500 Hz to 2 KHz.

The carrier gas preferably is an inert gas such as argon or helium, nitrogen or air-based, i.e. air or mixtures of air with i.e. N₂, or combinations thereof.

It is furthermore preferred that the carrier gas is provided in a dual-mixed flow geometry using two inlets for the carrier gas. Said inlets are preferably inlets of the spark chamber. It is furthermore preferred that the electrodes are arranged within the spark chamber as well.

Said dual-mixed flow geometry allows a reduction of the effective volume of the spark chamber which is advantageous in view of a small cluster size.

A small cluster size is in turn advantageous because the majority of the atoms in the cluster are at the surface and can actually participate in for instance in a catalytic conversion reaction. Therefore, the majority of the atoms are functional, whereas materials anything but clusters have most of their atoms in the core and are therefore dormant. For a cube of 100 nm, 1.6% of its atoms exist at the surface (total number of atoms is some 40 million).

Instead the 1 nm cube consist of 85 atoms of which 82% is at the surface. This means that with the same amount of material, roughly 50 times more surface atoms are produced that can be active in case of clusters versus nanoparticles.

By reducing the energy per spark, the cluster size can be reduced further.

Hence, in view of a size reduction it is preferred that the carrier gas is provided with a flow rate in the range of 10 lpm to 1000 lpm, more preferably in the range of 10 lpm to 30 lpm

Additionally or alternatively, the spark generated plasma preferably has an energy per spark in the range of 5 μJ to 400 μJ,

Additionally or alternatively, the spark generated plasma preferably has a repetition frequency in the range of 500 Hz to 2 KHz. In order to enhance a production rate with which the clusters are produced, a repetition frequency with which the spark generated plasma is generated is preferably maximized.

An electrode ablation rate is preferably determined by measuring a current of the positively or negatively charged clusters in the aerosol. To this end it is preferred that the spark ablation device further comprises a Faraday cup or the like that is configured to collect either negatively or positively charged clusters from the aerosol. The current can be measured via an electrometer and allows to determine the number of ions hitting the cup per unit of time giving a measure of the electrode ablation rate and thus of the cluster production rate.

Hence, the method according to the invention allows the production of clusters of a well-defined size and composition as well as at a high production rate.

In another aspect, the cluster as described above and/or as being produced in the method as described above is used as a catalyst for catalytic conversions or as an indicator for a sensor or as a conductor for an electronic circuit.

In particular, the inventors have found out that the above characteristics result in unique properties of the cluster according to the invention, which are beneficial for a variety of applications of the cluster. For instance, the cluster according to the invention comprises unique catalytic properties, which renders the cluster according to the invention very suited for use as a catalyst in catalytic conversions. In particular, the clusters according to the invention enable catalytic conversion reactions of very high selectivity. Moreover, the clusters offer a new catalyst design strategy for a selective catalytic synthesis of various chemicals such as the selective electrosynthesis of base chemicals.

Another application of the cluster according to the invention is as an indicator in a sensor, for instance as an adsorbent that can adsorb or otherwise interact with a target quantity such as binding to a target chemical. Due to the high surface atom to core atom ratio and high purity of the clusters, strong interaction between the cluster and the target molecule can exist. As a result, the target molecule cannot desorb and therefore accumulates at the surface. This results in 1) the target molecules high local concentration at the surface and 2) chemical changes to the surface which enables their accurate detection and quantification. Using well-known quantification techniques in the art such as reflectometry, Fourier transform infrared spectrometry (FTIR), Raman spectrometry, fluorescence microscopy, their accumulation can be probed, and via calibration, quantified. Furthermore, their accumulation can also be quantified via changes in resistance induced in the surface or its optical properties.

Another application of the cluster according to the invention is as a conductor in an electronic circuit. Interconnects and contacts in electronic circuits in chip manufacturing are produced using chemical vapor deposition. Here, a layer of conducting material is deposited on the wafer and etched away to yield the respective pattern that will provide the necessary interconnects and/or contacts in the chip. The precursor for such deposition methods are metal-organic compounds. This means that, by nature of the production method, ligands (or their decomposed states) are introduced into the conducting layer on the semi-conductor surface. As a result, the purity of the film is low (>80% metal), which can negatively affect the resistance (increase it) resulting in slower transistor performances. By means of a cluster deposition method, the present invention allows the generation of high-purity conductive or semi-conductive films, for example metal or metal oxide films, that are deposited on a substrate, for instance a wafer surface resulting in lower resistance contacts and faster transistor read outs, see further below.

In another aspect, an assembly comprising at least one cluster as described above and/or as being produced in the method as described above is provided, wherein the cluster is immobilized on a support.

The cluster and the support preferably form a composite material.

In other words, the assembly preferably comprises or consists of a composite material that is formed by the clusters being immobilized on the support. That is, the assembly preferably forms a composition of two components, namely the support and the clusters being immobilized thereon.

The support preferably is carbonaceous and/or silicon-based and/or aluminium-based and/or cerium-based and/or oxide-based such as comprising metal oxides and/or combinations thereof. Additionally or alternatively, the support is preferably functionalized.

In particular, the support preferably comprises at least one of graphite, in particular graphite nanoparticles, graphene, in particular graphene oxide nanoparticles, carbon black nanoparticles, multiwalled carbon nanotubes, zeolites, silicon (Si), silicon oxide (SiO2), aluminium oxide (Al2O3), or cerium oxide (CeO2) or combinations thereof. Additionally or alternatively, the support is preferably doped, in particular heteroatom-doped such as nitrogen-doped (N-doped), oxygen-doped (O-doped) or sulfur-doped (S-doped) boron-doped (B-doped) or combinations thereof. Additionally or alternatively, the support preferably comprises one or more ligation sites, the ligation sites preferably comprising amine-functional groups, imine-functional groups, amide-functional groups and/or being pyridinic nitrogen, pyrrolic nitrogen, NOx functional groups, C—O functional groups, C═O functional groups, C—OH functional groups or combinations thereof.

For instance, the support can be a heteroatom doped carbonaceous support comprising or consisting of N-edge functionalized graphite nanoparticles, N-edge functionalized graphene oxide nanoparticles, N-edge functionalized multiwalled carbon nanotubes, N-doped carbon black nanoparticles, or combinations thereof. However, other supports and/or functionalizations are likewise conceivable. For instance, supports comprising graphene oxide nanoparticles can have N- and/or NOx-ligation sites. Supports comprising N-doped carbon black nanoparticles can have —C═O, —OH and —COOH ligation sites, etc.

The support preferably comprises a nitrogen to carbon ratio N/C being larger than 0.09 and an oxygen to carbon ratio O/C being 0.1 or larger. Alternatively, the support preferably comprises a nitrogen to carbon ratio N/C being 0.05 or larger. Additionally or alternatively, the support preferably comprises an oxygen to carbon ratio O/C being 0.04 or larger, preferably being larger than 0.48.

Furthermore, the support preferably is a commercially available support or can be sourced from commercially available materials.

The assembly is preferably configured as a catalyst for catalytic conversions or as an indicator for a sensor or as a conductor for an electronic circuit

Hence, in another aspect a catalyst and/or an indicator for a sensor and/or a conductor for an electronic circuit comprising at least one cluster as described above is provided, and wherein the cluster is immobilized on a support.

Any statements made herein regarding the clusters preferably likewise apply to the catalyst and/or the indicator and/or the conductor comprising the clusters and vice versa.

The sensor comprising the indicator preferably is a gas sensor. To this end, a specific gas molecule can irreversible adsorb to the cluster configured as an indicator and induces changes for instance in the resistivity of the supported-cluster being measurable by means of an electrical circuit and/or induces changes in the reflectance, fluorescence, Raman or IR signal of the supported-cluster being measurable with a reflectometer, fluorescence microscope, IR spectrometer, Raman to quantify the amount and species of adsorbed molecule.

Moreover, an electronic circuit comprising the conductor can be the electronic circuit of a semi-conductor chip. hereto this end, the conductor of the electronic circuit is configured to conduct current, in particular through interconnects, which connect two or more circuit elements such as a transistor, and/or through contacts, which form the connection between the interconnects and the transistors. These conductors, e.g. the interconnects or the contacts, can comprise at least one cluster such as at least one metal or metal oxide cluster according to the invention, preferably Cu, Au or W, wherein the high-purity of the clusters lower the circuit resistance and accelerate the signal read-out process of the transistor.

In another aspect, a method of producing an assembly as described above is provided. The method comprises the steps of i) producing the cluster as described above, and ii) immobilize the cluster on the support.

Any statements made herein regarding the assembly as such preferably likewise apply to the method of producing the assembly and vice versa.

Furthermore, the support preferably is a support as described above.

The cluster is preferably immobilized on the support by at least one of deposition, filtration, diffusion, impaction, printing or combinations thereof. The cluster is preferably immobilized by electrostatic deposition such as an electrostatic precipitation deposition. Additionally or alternatively, the cluster is preferably immobilized by a filter deposition and/or wherein the cluster is transported into, and optionally through, the support by an aerosol stream comprising the cluster.

That is, various ways of immobilizing the clusters on the support are conceivable such as via deposition and/or filtration and/or diffusion and/or impaction and/or printing and/or combinations thereof. For instance, the clusters can be immobilized via deposition such as electrostatic deposition and/or a filter deposition. The clusters are preferably deposited on the support in a deposition chamber. That is, the spark ablation device preferably comprises a deposition chamber.

The electrostatic deposition can be an electrostatic precipitation deposition. In this case it is preferred that the clusters are charged and precipitated by applying an electric field, in particular by applying a voltage to a substrate (see further below), whereby a bias of the substrate can be applied to the support. That is, the clusters upon their formation in the spark ablation can be positively or negatively charged, and wherein the application of an electric field, in particular a voltage of appropriate sign to the substrate, enhances their precipitation or collection on the support. For example, negatively charged clusters can be collected on the support via electrostatic precipitation by applying a positive voltage to the substrate.

Additionally or alternatively, the clusters can be immobilized via filter deposition, and wherein the clusters are preferably transported into, and optionally through, the support by an aerosol stream comprising the cluster. That is, and as mentioned earlier, the spark ablation preferably generates an aerosol stream comprising the cluster, and wherein the cluster can be deposited and thus immobilized on the support when the aerosol stream flows into and possibly through the support.

The support is preferably applied to a substrate. The substrate is preferably porous and/or gas diffusive. The cluster is preferably immobilized on the support when the aerosol stream comprising the cluster flows through the substrate.

As mentioned above, the cluster can be immobilized on the support via a filter deposition, in which the aerosol stream comprising the clusters being formed during the spark ablation, in particular by the spark generated plasma that ablates the electrodes, is transported into or through the support. To this end it is particularly preferred that the support is applied to a substrate, and that the aerosol stream is furthermore passed into or through the substrate comprising the support.

Again in other words, a cluster deposition on the support preferably occurs via filtration, wherein the substrate serves the purpose of a filter that is filtering the clusters from the aerosol stream.

In this regard it is noted that filtration does not necessarily require the presence of a substrate, i.e. if the aerosol cluster stream is mixed with an aerosol stream of support, immobilization of the clusters can be achieved without the need of a substrate. In the case of the electrostatic precipitation, a bias must be applied to the support to attract the clusters to it, if the support is not applied to a substrate, a bias cannot be supplied.

Various substrates are conceivable, such as a substrate in the form of a gas diffusion layer, for example a carbon paper-based gas diffusion layer.

The support is preferably applied to the substrate prior to an immobilization of the cluster on the support.

Various ways of applying the support to the substrate are conceivable. One convenient way is to airbrush an ink composition onto the substrate. Airbrushing is a well-known process that finds various applications, for instance in the car industry in order to apply paint to a car. Airbrushing the support to the substrate renders the manufacturing scalable in an easy manner. Furthermore, production steps such as those associated with the electrostatic deposition can be dispensed with, which facilitates production and improves the speed of production.

The application of the support to the substrate preferably produces a support-substrate composite. Said composite is preferably produced prior to an immobilization of the cluster on the support, in particular prior to an immobilization of the cluster on the support-substrate composite.

Various support-substrate composites are conceivable, for instance a carbonaceous support-carbon paper-based gas diffusion layer composite.

The ink composition preferably comprises the constituents of the support being dispersed in at least one solvent. The solvent preferably is an organic solvent such as an alcohol, for instance isopropanol, although other organic solvents such as aromatic solvents, esters, ethers, ketones, acetone, etc., and/or inorganic solvents are likewise conceivable.

The ink composition preferably furthermore is an aqueous solution, wherein the aqueous solution comprises the at least one solvent and the constituents of the support. For example, the ink composition can be a mixture of isopropanol and water, wherein the constituents of the support such as N-doped carbon black nanoparticles are dispersed.

After the ink composition is applied to the substrate, it is preferred that the at least one solvent is evaporated. In order to facilitate a solvent evaporation the substrate is preferably heated.

In another aspect, the assembly as described above and/or as produced in the method as described above is used as a catalyst in catalysis, in particular in a catalytic conversion such as a thermal conversion, an electrochemical conversion or a photochemical conversion.

In another aspect, a method of catalytically converting at least one reactant is provided. The method comprises the steps of i) supplying at least one reactant, ii) providing the assembly described above and/or as produced in the method as described above, and iii) contacting the at least one reactant with the catalyst to form at least one product from the at least one reactant by catalytic conversion.

To this end it is particularly preferred that at least two reactants are reacting with one another so as to form at least one product. The catalyst preferably initiates said reaction, e.g. a chemical reaction i.e. by bringing the two reactants in close proximity to one another and deforming their spatial arrangement to resemble the product thereby lowering the activation energy of the reaction, whereby the catalytic conversion of the reactants to the product(s) is initiated.

Various reactants, products and catalytic conversions are conceivable.

For instance, the reactants and/or products can be organic or inorganic reactants. Furthermore, the reactants and/or products can be in a gaseous or liquid state before and/or during and/or after the catalytic conversion.

In particular, conceivable reactants comprise or consist of unconverted hydrocarbons, water (H2O), nitrogen (N2), alcohol-based compounds, aldehyde-based compounds, COx compounds, or mixtures thereof. An example of an unconverted hydrocarbon is an alkene, for instance ethylene. An example of an aldehyde-based compound is a dialdehyde such as glyoxal. An example of a COx compound is carbon dioxide (CO2).

Conceivable products comprise or consist of converted hydrocarbons, hydrogen (H2), oxygen (O2), nitrogen-based compounds, COx compounds, aldehyde-based compounds, carboxylic-based compounds, carbonyl-based compounds, alcohol-based compounds or mixtures thereof. An example of a nitrogen-based compound is ammonia (NH3). An example of a COx compound is a carbon oxide, such as carbon monoxide (CO). An example of an aldehyde-based compound is acetaldehyde. Examples of carboxylic-based compounds are carboxylic acids such as acetic acid or formic acid or dicarboxylic acids such as oxalic acid. An example of a mixture of an aldehyde-based and a carboxylic-based compound is glycoxylic acid. An example of a carbonyl-based compound is a ketone-based compound such as acetone. Examples of alcohol-based compounds are aliphatic alcohols, for instance methanol, ethanol, propanol.

The catalytic conversion can be a thermal conversion, an electrochemical conversion or a photochemical conversion.

The electrochemical conversion reaction preferably is a CO2 reduction reaction (CO2RR). For instance, the method according to the invention enables the electrochemical conversion, in particular the electrochemical reduction reaction of carbon dioxide (CO2) to acetaldehyde, wherein carbon dioxide is contacting the catalyst according to the invention and wherein two carbon dioxide molecules are adsorbed to the catalyst comprising cathode and in combination with four protons and four electrons are reduced to from two carbon monoxide molecules and two water molecules and in which two carbon monoxide molecules are further coupled and reduced in combination with a further six protons and six electrons to form one molecule of acetaldehyde and one molecule of water.

As another example, the method according to the invention enables the electrochemical conversion, in particular electrochemical water splitting to produce hydrogen, wherein protons contacting the catalyst according to the invention and wherein two protons are adsorbed to the catalyst comprising cathode and in combination with two electrons are reduced to from one hydrogen molecule.

In order to perform the conversion reaction with high selectivity it is preferred that at least some of the components of the catalyst are provided in accordance with the type of conversion reaction and the reactants to be converted, respectively.

For instance, if the catalytic conversion corresponds to an electrochemical conversion, wherein molecular oxygen (O2) is generated from water (H2O) in an oxygen evolution reaction, it is preferred that the catalyst comprises or consists of clusters that exhibit enhanced activity towards oxygen such as iridium, cobalt, iron or ruthenium or mixtures thereof (Chem. Soc. Rev., 2020,49, 2196-2214). That is, in the event of an oxygen evolution it is preferred that the clusters comprise or consist of core atoms and surface atoms being at least one of iridium, cobalt, iron or ruthenium or mixtures thereof. Such clusters can easily be manufactured by providing the electrodes used in the spark ablation from the corresponding element or elements, respectively.

Preferred elements for water splitting are nickel and/or platinum. Preferred elements for the electrochemical reduction reaction of carbon dioxide (CO₂) to carbon monoxide (CO) are silver and/or gold. It is furthermore preferred that the support is adapted to conditions of the conversion reaction. For example, in thermal catalysis, high heat is usually generated, so that a heat-resistant support is preferably used. As such, catalysts comprising supports that comprise or consist of zeolites, SiO2, Al2O3, CeO2 or mixtures thereof are preferred in thermal catalysis reaction. It should be noted that these examples are not exhaustive but that many other elements could likewise be used.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematics of a spark ablation (A) and immobilization (B) of Cu(—Ag) oxide clusters on heteroatom doped carbonaceous support GDL composites; shows an advanced characterization of the as-synthesized Cu(—Ag) oxide FIG. 2 clusters immobilized on heteroatom doped carbonaceous support. (A-B) STEM-HAADF images of the Cu and Cu—Ag—NCB catalyst. (C-D) STEM-EDXS elemental maps of the images in A and B showing Cu in dark-grey and Ag in light-grey. Scale bars indicate 10 nm. (E-F) Radial distribution functions extracted from the EXAFS spectra of the Cu—NCB and -GO catalyst, respectively. CuO, CuPc and Cu(acac)2 were used as a reference. (G-H) XANES spectra of the Cu—NCB and -GO catalyst, respectively. A linear combination fit (LCF) of the CuO and CuPc and Cu(acac)2 reference spectra puts the contribution of the ligation sites to catalyst structure at 48% and 28%, respectively;

FIG. 3 shows (A-B) selectivity screening of Cu—NCB and Cu-GO GDL composites, respectively. (C-D) Selectivity screening of Cu—Ag—NCB and Cu—Ag-GO GDL composites, respectively. All electrochemical reactions were carried out in CO2 saturated 0.1 M KHCO3 electrolyte in Nafion® membrane separated H-cell. Chronoamperometry was carried out in a cathodic potential window of −0.5 to −1.1 V vs RHE (half-cell potential) with 100 and lastly 200 meV increment (IR-drop corrected) using an Ag/AgCl reference electrode. A Pt foil (1 cm²) was used as counter electrode. Gaseous products were quantified via gas chromatography. Liquid products were detected using H-NMR and quantified using the Kuhl et al. protocol. 10 For the lower overpotential experiments (<800 meV), liquid products were collected for at least 3 hrs for reasonable statistics. For all other potentials, FEs were averaged for a minimum of 30 min. Error bars represent standard deviations of at least two independent measurements. The less than 100% FE observed for the Cu—Ag-GO-GDL at −0.5 V vs RHE stems from unquantifiable gaseous products due to dilution of the CO2 stream (H2 most likely);

FIG. 4 shows (A) stress test of the Cu—NCB GDL at −0.6 V vs RHE in 0.1 M KHCO3. (B—C) Radial distribution functions extracted from the EXAFS spectra of the Cu—NCB and -GO catalyst, respectively, after catalysis and exposure to air. Cu, CuPc and Cu(acac)2 were used as a reference. (D-E) XANES spectra of the Cu—NCB and -GO catalyst, respectively, after catalysis and exposure to air. A linear combination fit (LCF) of the Cu and CuPc and Cu(acac)2 reference spectra puts the contribution of the ligation sites to catalyst structure at 40% and 30%, respectively;

FIG. 5 shows (A) in situ XANES spectra of the Cu—NCB catalyst in 0.1 M KHCO3 as a function of the potential. Each spectrum depicted is an average of three acquired spectra (20 min each) used for signal-to-noise enhancement. (B) In situ EXAFS spectra of the Cu—NCB catalyst in 0.1 M KHCO3 between −100 and ~300 mV vs RHE. Scattering paths of Cu₂O (powder) and Cu (foil) are offered as references;

FIG. 6 shows BF-TEM images of the carbonaceous support materials synthesized for cluster immobilization. A-B) Produced via the mechanical route i.e. ball milling that are nitrogen rich: NG-NPs5, NMWCNTs.5,6 C-D) Produced via chemical routes i.e. pyrolysis and oxidation: NCB-NPs4 and GO-NPs1, respectively. A) N-edge functionalized graphene nanoparticles. B) N-edge functionalized multiwalled carbon nanotubes. C) N-doped carbon black nanoparticles. D) Graphene oxide nanoparticles;

FIG. 7 shows aspects of the spark ablation and electrostatic deposition experimental set-up, operation, and electrical components;

FIG. 8 shows diagrams depicting size distributions of charged clusters produced in the aerosol as measured by a differential mobility analyzer (DMA) to determine the cluster mobility (and thus size) and the production rate measured via a Faraday cup of the set-up depicted in FIG. 7(A) and an electrometer;

FIG. 9 shows a diagram depicting a size distribution and production rate of the positively charged Cu—Ag oxide clusters with an average size of 1.5 nm, which showed the smallest size and highest production rate whilst maintaining a stable spark;

FIG. 10 shows BF-TEM images of the electrostatic precipitation deposition of 0.5 mL equivalent of 1.6 nm CuO and 1.5 nm CuAgO clusters on four different carbonaceous supports;

FIG. 11 shows advanced EM investigations of the 0.5 ML of CuO clusters electrostatically precipitated on the NCB support;

FIG. 12 shows advanced EM investigations of the 0.5 ML of CuO clusters electrostatically precipitated on the MWCNT support;

FIG. 13 shows advanced EM investigations of the 0.5 ML of CuAgO clusters electrostatically precipitated on the NCB support;

FIG. 14 shows advanced EM investigations of the 0.5 ML of CuAgO clusters electrostatically precipitated onto the MWCNT support;

FIG. 15 shows a diagram depicting secondary electron cut-off measured with XPS of the heteroatom doped carbonaceous supports;

FIG. 16 shows BF-TEM image of the bare MWCNTs. Lattice fringes can be discerned showing the crystalline nature of the nanotubes;

FIG. 17 shows a schematics of an air brush experiment to produce heteroatom-doped carbonaceous support-carbon paper composites;

FIG. 18 shows a loading study of the airbrushed heteroatom doped carbonaceous support. (A-C) SEM images of NCB-NPs coated on carbon paper at 0.3, 0.6 and 0.9 mg cm-2. (D-F) SEM images of NG-NPs coated on carbon paper at 0.3, 0.6 and 0.9 mg cm-2. (G-H) SEM images of GO-NPs coated on carbon paper at 0.3 and 0.9 mg cm-2;

FIG. 19 shows a composition study using SEM-EDXS. (A-C) SEM images of the composite materials produced in FIG. 18. (D-F) SEM-EDXS elemental maps of the composite materials depicted in A-C in which a homogenous distribution of dark-grey (oxygen), black (carbon) and light-grey (nitrogen) pixels can be observed;

FIG. 20 shows filtration of metal oxide clusters produced via spark ablation on heteroatom doped carbonaceous support composited. Deposition time in all instances 10 hrs. (A,B) SEM image of the Cu oxide cluster coated GO- and NCB—NP composites showing no clear difference with uncoated samples in FIG. 18. This is due to the fact that the cluster size is below the limit of detection of SEM. (C-D) SEM-EDXS elemental map of the Cu oxide cluster coated GO-, NCB—NP coated composites, respectively, clearly showing a homogenous Cu signal (in light-grey) proving the successful coating step. Ablation rate determined mass loading of 4 μg cm-2. (E-F) SEM-EDXS elemental maps of the CuAg oxide cluster coated GO- and NCB—NP coated composite materials, respectively, showing a homogeneous distribution of Cu and Ag indicated in light-grey and white, respectively. Ablation rate estimated mass loading of 3 μg cm-2;

FIG. 21 shows XPS studies of the oxidation state of the CuAg oxide clusters deposited on carbon paper, 2 hrs (A-D) and 7 days after deposition (E-H);

FIG. 22 shows XPS studies of the bonding nature of the surface carbon and oxygen of the various supports.

FIG. 23 shows an 1H-NMR spectrum taken of a catholyte aliquot after CO2RR using a Cu—Ag—NCB-GDL catalyst at 0.9 V vs RHE for 1 hrs;

FIG. 24 shows an 1H-NMR spectrum of metaldehyde dissolved in 0.1 M KHCO3;

FIG. 25 shows diagrams depicting (A) selectivity as a function of potential of the as-synthesized NCB-GDL composite. (B) Selectivity as a function of potential as the as-synthesized GO-GDL composite;

FIG. 26 shows diagrams depicting geometrical current density as a function of potential of the as-synthesized GO-GDL composite. (B) Geometrical current density as a function of potential as the as-synthesized NCB-GDL composite;

FIG. 27 shows diagrams depicting geometrical current densities as a function of potential for the screened Cu-(ag)-NCB/GO GDL catalysts at low overpotential.

### DESCRIPTION OF PREFERRED EMBODIMENTS

Various aspects of the invention will now be explained with reference to the figures.

### Catalyst Synthesis and Characterization.

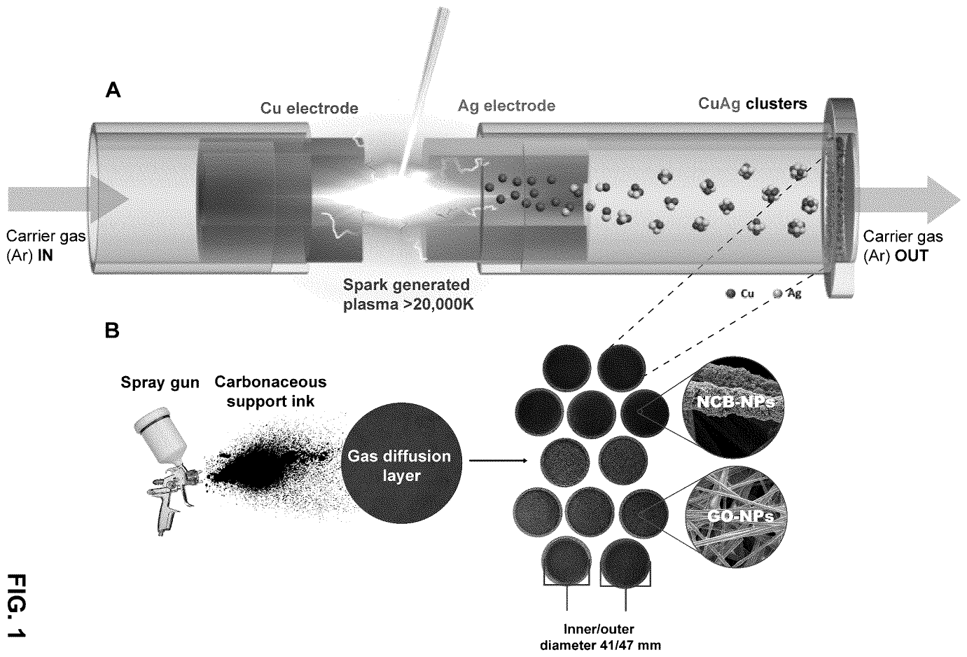

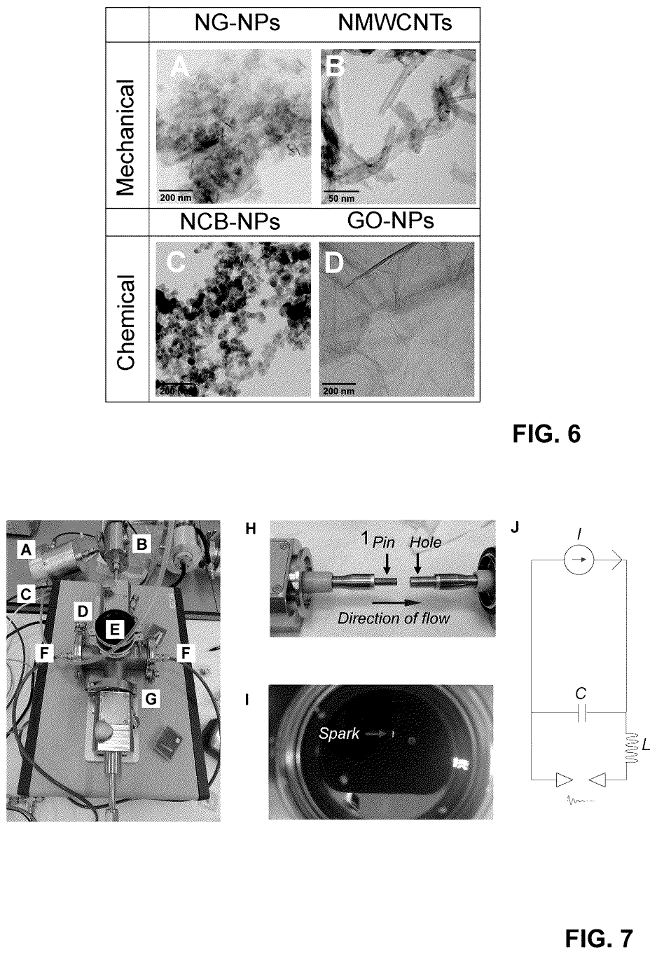

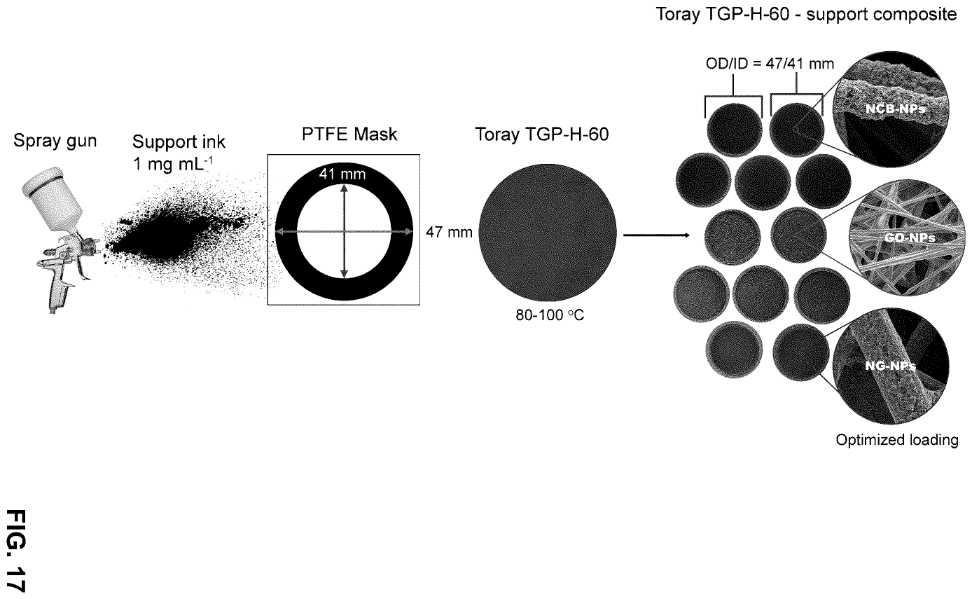

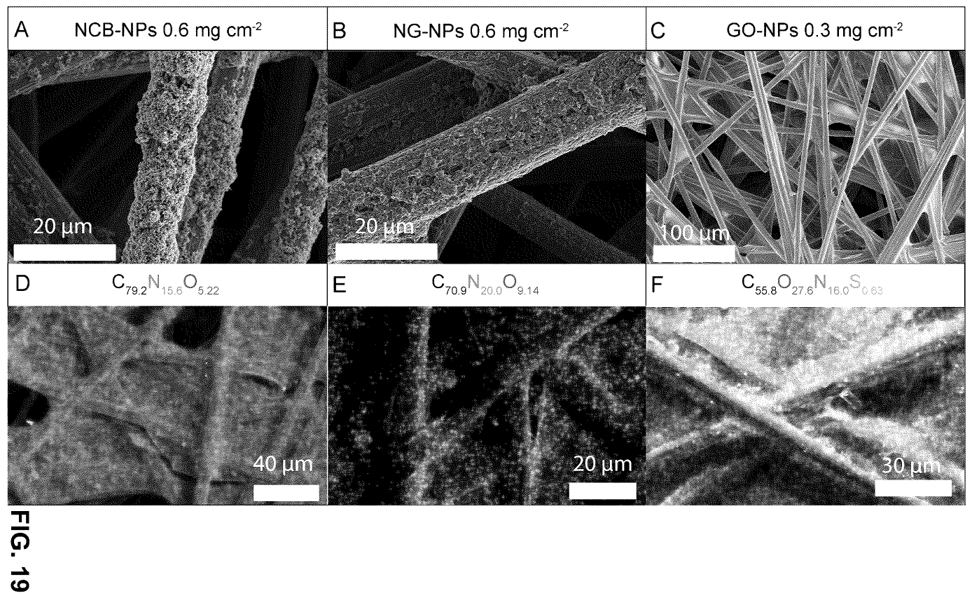

A method of producing an assembly comprising clusters being immobilized on a support such as a catalyst is depicted in FIG. 1. In brief, a power source is applied to two hollow metal electrodes (Cu—Cu or Cu—Ag) in between a gap through which a carrier gas (Ar) is flowed (FIG. 1A). Upon the breakdown of the potential, the gas is briefly ionized (~μs) and becomes conductive creating a plasma pulse producing temperatures>20,000 K (similar to the workings of a spark plug)[31]. By controlling the gas flow rate, repetition frequency, and energy per spark, the electrode ablation rate can be controlled producing an aerosol of clusters of well-defined size and composition [32,33]. However, the high degree of undercoordination of the cluster produced makes them extremely susceptible to agglomeration. Therefore, a selection of heteroatom doped carbonaceous supports with strong cluster-support interaction, i.e., graphene oxide and N-doped carbon black nanoparticles (GO-, NCB-NPs) synthesized in-house at >1 g scale [34,35] were used for successful immobilization. Finally, cathodes were fashioned from a commercial gas diffusion layer (GDL) air brushed with an optimized loading of carbonaceous support, and used as filters to collect the clusters from the aerosol stream (FIG. 1B). For information regarding the synthesis of the catalyst supports, see Note S1 and FIG. 6 of the Supporting Information. For details on the cluster production see Note S2 and FIG. 7-9. For details on the cluster immobilization see Note S3-S4 and FIG. 10-16. For details on the cathode production process see Note S4 and FIG. 17-20.

That is, FIG. 1 depicts a schematics of a spark ablation (A) and immobilization (B) of Cu(—Ag) oxide clusters on heteroatom doped carbonaceous support GDL composites.

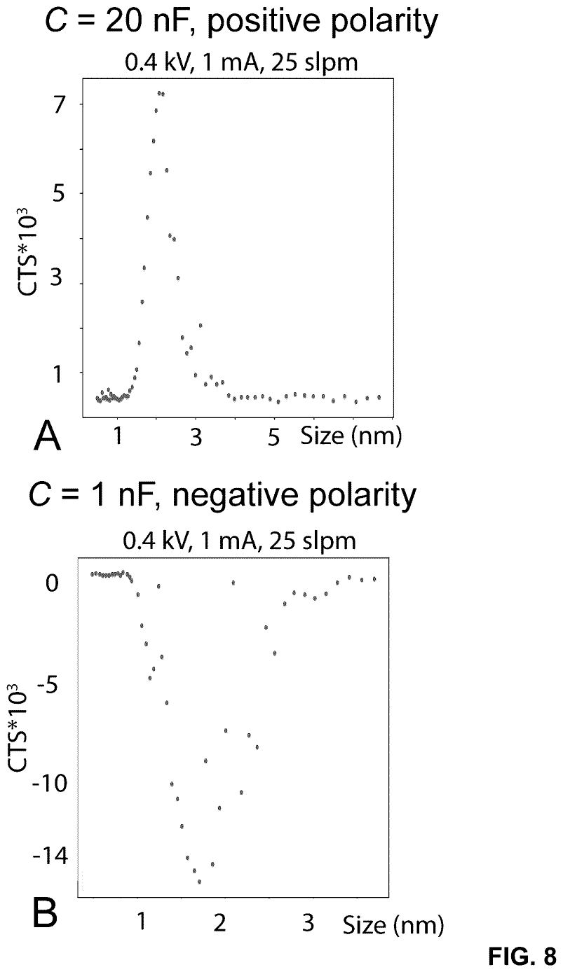

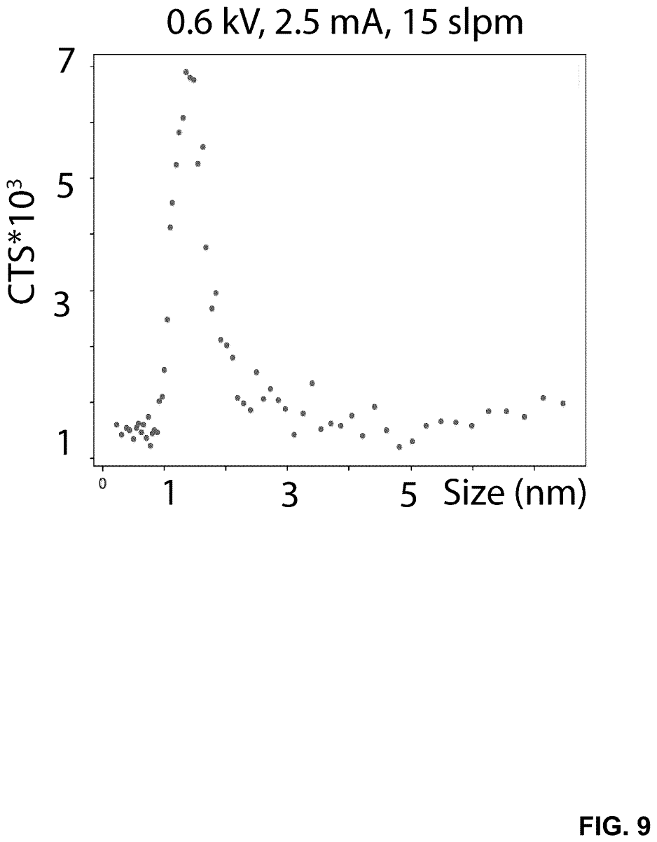

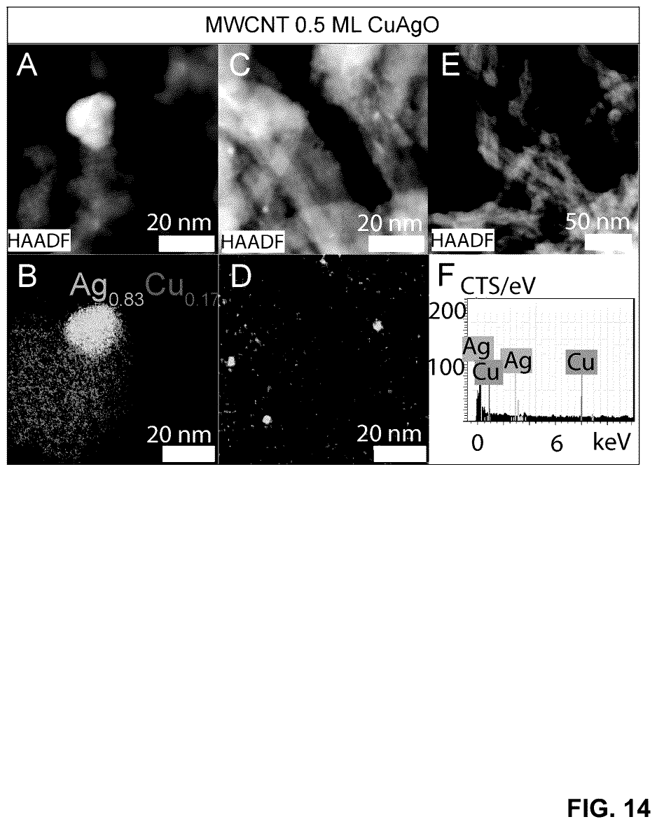

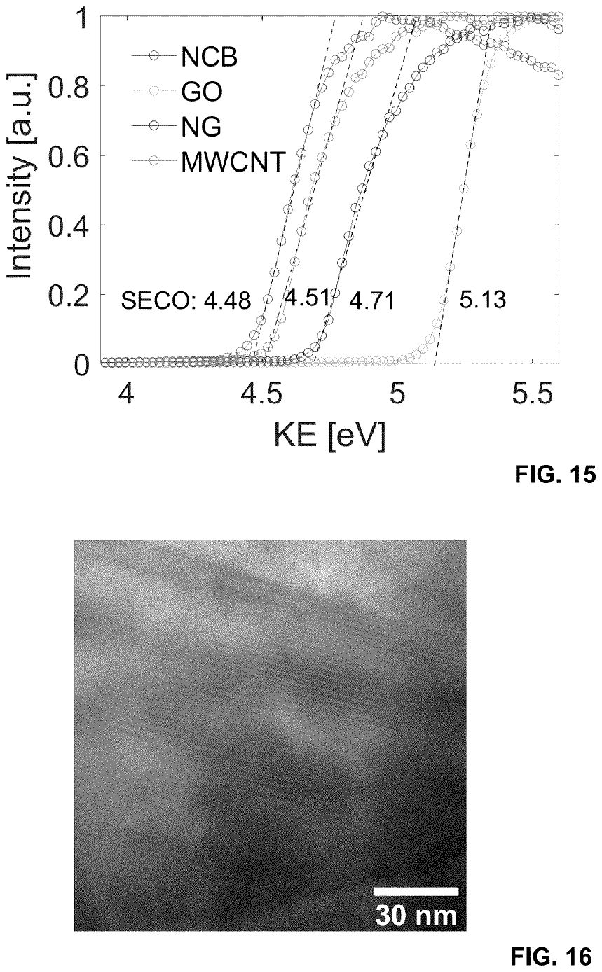

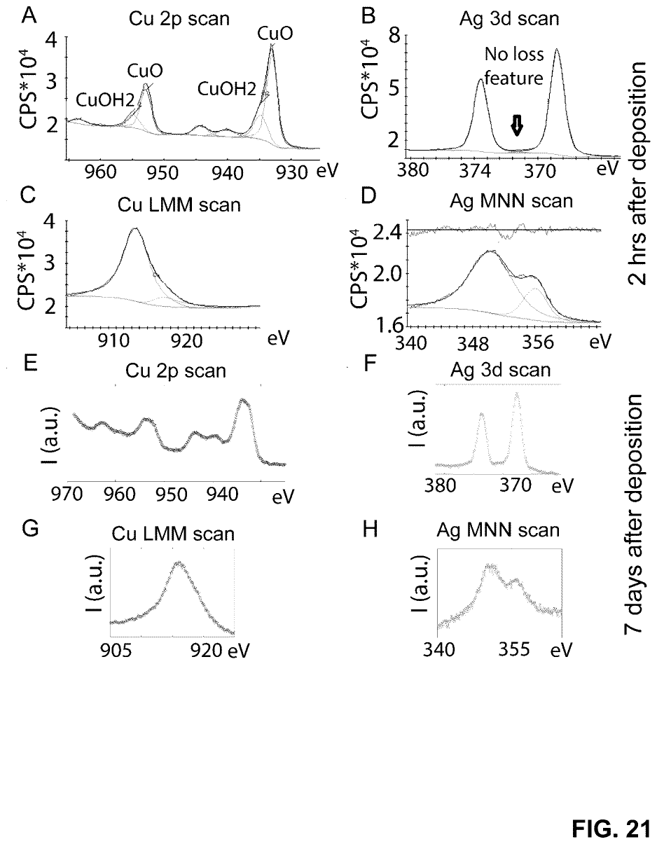

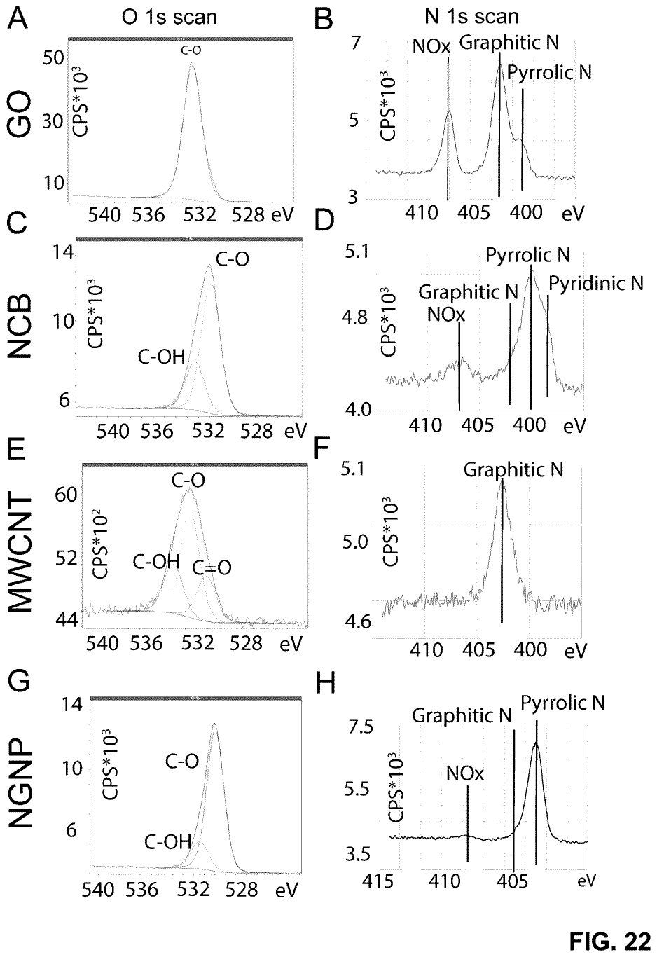

Four ~0.1 wt % metal catalysts were produced and denoted Cu(—Ag)-GO and Cu(—Ag)—NCB. We investigated the size of the clusters produced in the aerosol with a differential mobility analyzer (DMA) and the state of the immobilized clusters using scanning transmission electron microscopy high-angle annular darkfield (STEM-HAADF) imaging (FIG. 2, FIG. 10-14). The average Cu and Cu—Ag cluster size of 1.6 and 1.5 nm measured with the DMA (FIG. 8-9) was confirmed with STEM-HAADF with the FWHM of Cu, respectively, Cu—Ag clusters of 1.5±0.5 and 1.4±0.3 nm (FIG. 2A-B, 11 and 13). Interestingly, when N-edge functionalized graphene and multiwalled carbon nanotubes were used as supports, cluster agglomeration was observed (FIGS. 12 and 14). The strength of the cluster-support interaction was not a measure of the support work function (FIG. 15). Instead, both the crystallinity and absence of specific ligation sites explained the difference (FIG. 16-17). STEM-energy dispersive X-ray spectroscopy (EDXS) was used to confirm the Cu, respective, Cu—Ag nature of the STEM-HAADF identified clusters (FIG. 2C-D). And determined the average composition of the bimetallic clusters at Cu84Ag16 (at. %), which was later confirmed with X-ray photoemission spectroscopy (XPS, FIG. 21). XPS further pointed towards the complete oxidation of the clusters to Cull and AgI after 7 days (directly after deposition some CuI species could still be observed, which is an effect of purity of the Ar used as carrier gas, FIG. 21). The coordination structure and oxidation state of the Cu atom in the as-synthesized catalysts was further investigates with X-ray absorption spectroscopy (XAS, FIG. 2E-H). The radial distribution function extracted from the extended X-ray absorption fine structure (EXAFS) spectra excluded the presence of Cu2O, Cu(OH)2 and or metallic Cu species corroborating the XPS results. Further, a Cu—Cu scattering event in the second coordination shell of CuO could be discerned to a higher and lesser degree for the NCB—, respectively GO-based catalysts (FIG. 2E-F). The Cu coordination numbers of 3±0.6, respectively Cu 2±0.4 (vs 4 in the bulk) agrees with the small cluster size and further indicates a slightly stronger support interaction with GO than with NCB. This is most likely due to the higher density of ligation sites on the GO-support (heteroatom content ~50% vs ~30% for NCB). Further, by considering Cu phthalocyanine (CuPc) and Cu acetylacetonate (Cu(acac)2) as a reference, the ligation site of the clusters could be probed showing a strong contribution from Cu—N and Cu—O bonds in the first coordination sphere. In the case of Cu—NCB, these are most likely pyrrolic and pyridinic N and NOX (FIG. 22A-D). For the Cu-GO, this is either from NOX or C—O or C—OH species (FIG. 22A-D). Linear combination analysis of the near edge structure (XANES) spectra puts their relative contribution >28% (FIG. 2G-H).

### Electrochemical Screening of the Cu(—Ag) Oxide Cluster Carbonaceous Support Composite Electrodes.

We subjected our Cu—(Ag)—NCB/GO GDL composites to a series of electrochemical screening tests to determine their activity in CO2RR. Electrochemically speaking, the cluster support composites differ in two major ways: 1) NCB and GO are respectively a good and poor CO2RR electrocatalyst for the production of CO [36,37], which could explain differences in performance by means of tandem-effects upon the introduction of the clusters and 2) have different support-cluster interactions of varying strength, i.e. via N- and NOx-ligation sites in the case of NCB and C═O,OH and COOH groups for GO, respectively, which may affect the performance, i.e. similarly to what has been observed for atomically precise ligand capped Au clusters [39]. Further, since support effect have been invoked to explain performance differences in Cu3-4-cluster-NCB/GO based composites in the past [28,29], we deemed it of utmost importance to carefully deconvolute the contribution of the support from the cluster based composites. Therefore, before we investigated the effect of the introduction of clusters, we first determined the activity of the supports themselves.

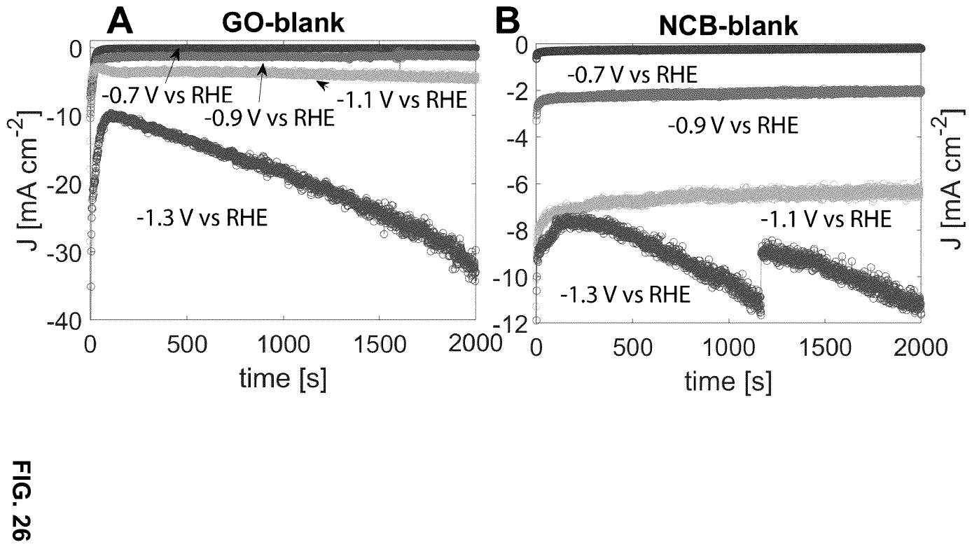

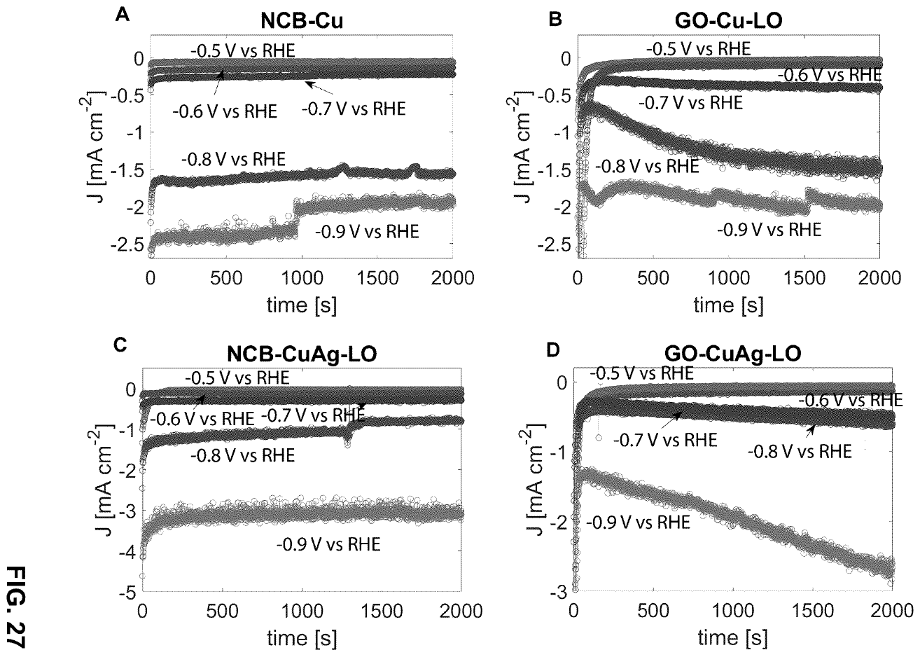

As expected, the NCB catalyst showed good selectivity (>90%) for CO, even at modest overpotential of 600 meV (FIG. 21A) whereas the GO support was poorly selective for CO2RR and produced H2 as a majority product at all potentials tested (FIG. 25B). Some HCOO-could be detected in the catholyte but never more than 20% of the current was directed towards this product. Further, even though several acid washing steps had been performed, trace amounts of Mn leftover from the graphite oxidation step could not be fully excluded, which may explain the observed CO as a minority product [40]. Nevertheless, the strongly differentiating CO activities (2 mA cm-2 vs 40 μA cm-2 for NCB and GO, respectively) ensures the exclusion of CO-coverage effects in case of the cluster-GO composites. Finally, material degradation for potentials more cathodic than-1.1 V vs RHE could be observed for either support offering the upper limit for the potential screening of the clusters-based composites (FIG. 26).

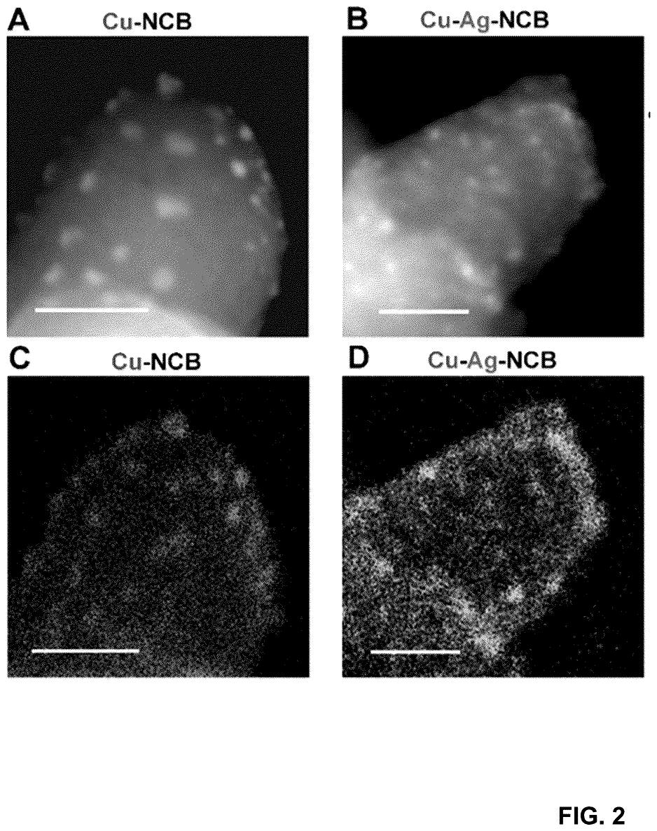

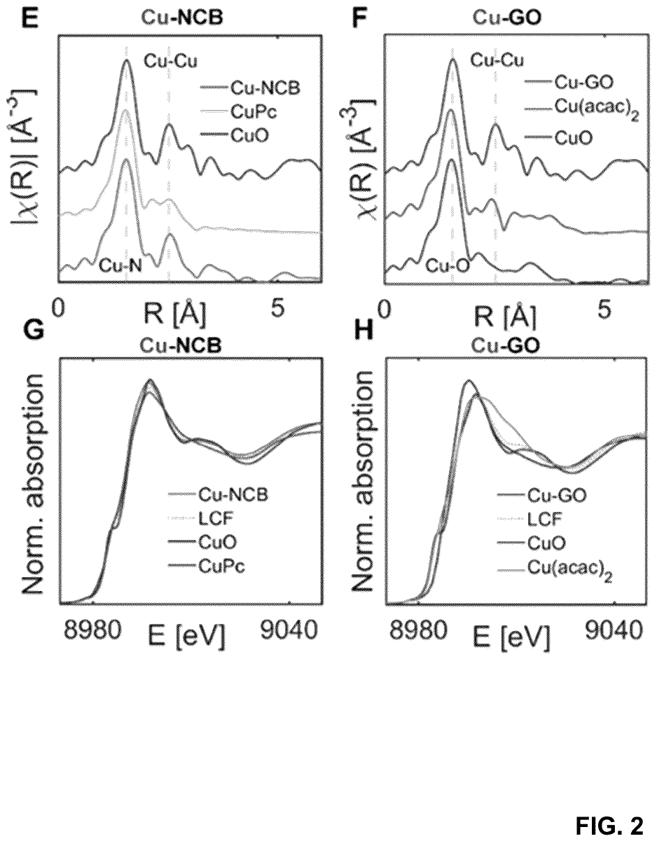

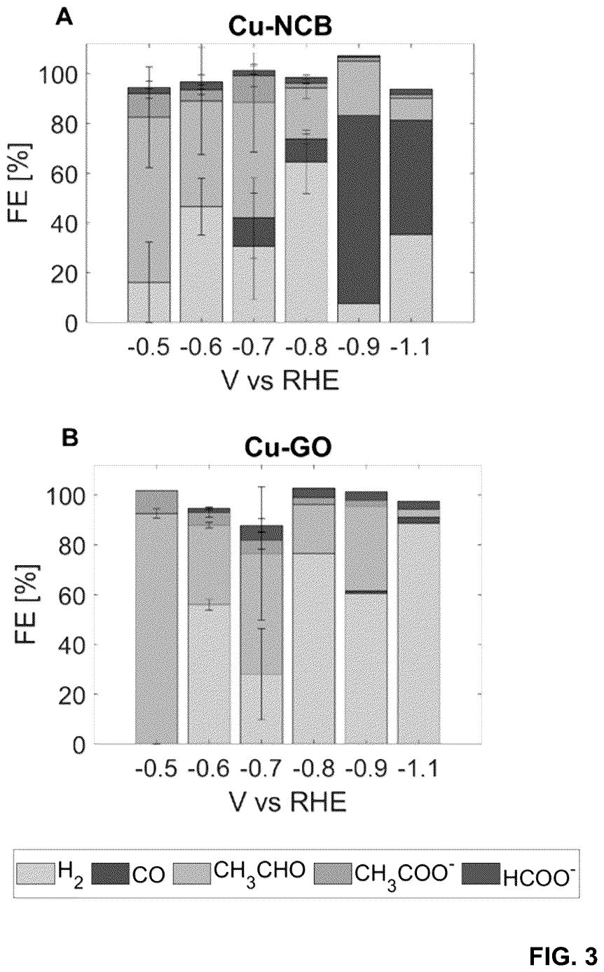

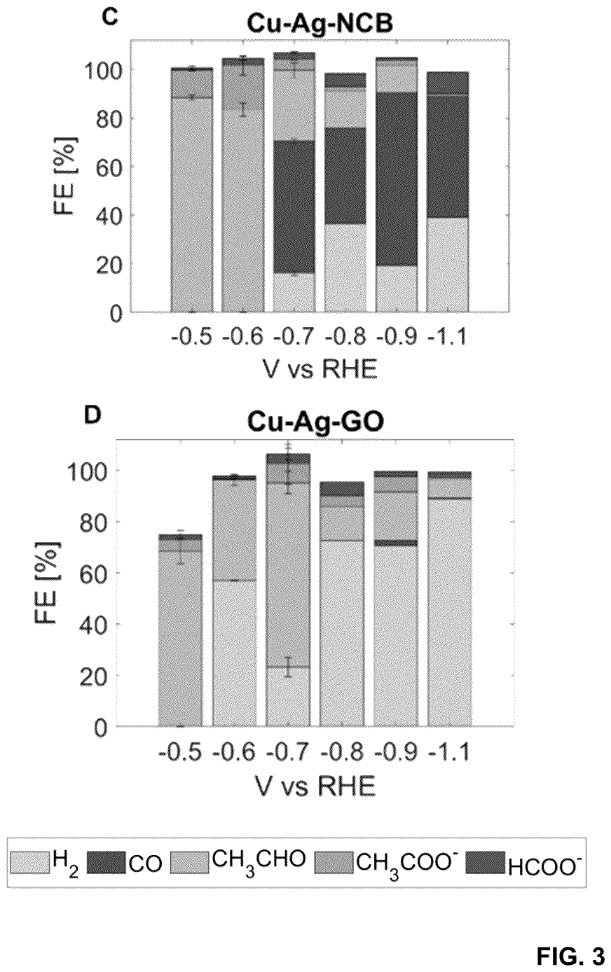

With the activity of the supports quantified, the effect of the introduction of Cu(—Ag) clusters could be investigated. FIG. 3 shows the chronoamperometry experiments performed used to determine the selectivity as function of potential, support and type of cluster. Independently of the support (FIG. 3A-B), acetaldehyde could be observed at any potential between −0.5 and −1.1 V vs RHE upon the introduction of Cu oxide clusters. As well as acetate, two electron transfers less reduced than acetaldehyde, as a minor product (<10%) and formate (<10%) at higher overpotential. Only for the NOB based samples was CO a notable product and especially at high overpotential which stems clearly from the support activity. Further, especially at lower overpotentials (more cathodic than-0.8 V vs RHE), significant acetaldehyde selectivity's could be reported. For Cu—NCB-GDL at-0.5 V vs RHE, an acetaldehyde selectivity of 66±20% was determined. At the same potential, for Cu-GO, the FEs was as high as 92±2%. For the NCB based catalyst enhancement of the overpotential by one or two decades, put the acetaldehyde FEs in the 40-50% range. Interestingly, for Cu-GO, the selectivity decreased to around 30% at-0.6 V vs RHE to then increase to nearly 50% at-0.7 V vs RHE. We assign this to a phase-transition of the GO support at-0.6 V vs RHE (i.e. −1.2 V vs Ag/AgCl) absent for NBC Further enhancement of the overpotential reduced the acetaldehyde selectivity independent of the support but remained >10% upto −0.9 V vs RHE. Interestingly, upon the introduction of 8 at. % Ag into the clusters, a similar trend could be observed as for pure Cu oxide clusters (FIG. 3C-D). However, for the Cu—Ag—NCB catalyst, at-0.5 V vs RHE the selectivity towards acetaldehyde was as high as 88±1% and 83±3% a century more cathodic. The C2+ selectivity was approximately 100% for either potentials. For the Cu—Ag-GO catalyst, again the selectivity dropped at-0.6 V vs RHE but more importantly, a ~70% selectivity could be maintained at-0.7 V vs RHE.

### Resistance Against Potential Cycling

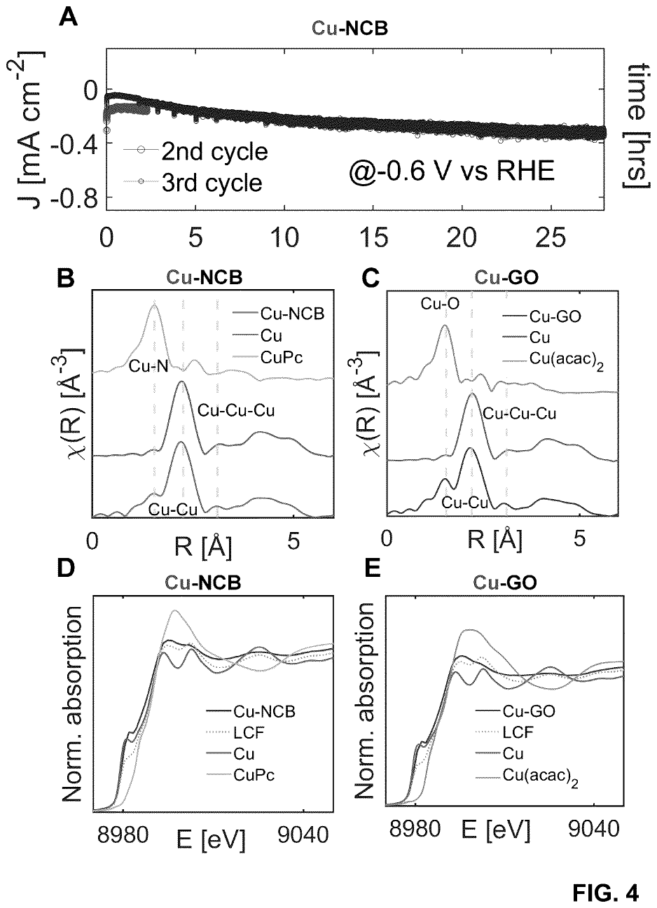

An optimal catalyst is not only selective, it remains stable for long hours of operation and is indifferent to start-stop cycles [42]. Therefore, we subjected one of our catalyst, the Cu—NCB GDL catalyst, to a stress test (FIG. 4). First, we took a previously screened catalyst sample, exposed it to air for several hours, and then ran the operation again (FIG. 4A, cycle 2). Notably, neither the current density (200 μA cm-2) nor the acetaldehyde selectivity (40-50%) changed. We then repeated this process for a second time but extended the reaction time 10-fold and let it run for nearly 30 hrs (FIG. 4A, cycle 3). After an initial stage of equilibration (first 3 hrs), a stable performance was obtained equivalent to the first and second cycle. To determine the reason of this remarkable resistance against start-stop cycles, we investigated the nature of our catalysts post-catalysis using EXAFS and XANES (FIG. 4B-E). Interestingly, the EXAFS spectra showed that the clusters had not only reduced fully upon applied potential [43], they had retained their metallic state even after exposure to air and independently of the support, i.e. NCB or GO (FIG. 4B-C). Similar to the pre-catalysis samples, Cu—N and Cu—O contributed significantly to the overall signal, which was confirmed by XANES linear combination analysis, and is suggested to originate from the cluster-support interaction (FIG. 4D-E). However, post catalysis, the majority of the EXFAS intensity originated from a Cu—Cu single scattering event of metallic Cu for either catalyst. Fitting of the Cu coordination shell estimates a Cu—NCB, -GO catalyst Cu coordination number of 5.6±0.86 and 4.8±0.79 (versus 12 in the bulk), respectively [44]. And using Frenkel's method [45,46], we translate that into an average cluster size of 0.98 and 0.87 nm, respectively, which is excellent agreement with a reduced CuO cluster size of 1.6 nm (FIG. 2). We, therefore, conclude that the recyclability of the Cu(—Ag) cluster-supported catalysts, is a direct result of their in situ transformation towards a metallic species, and their subsequent resistance towards oxidation [47].

### Identification of the Active Site

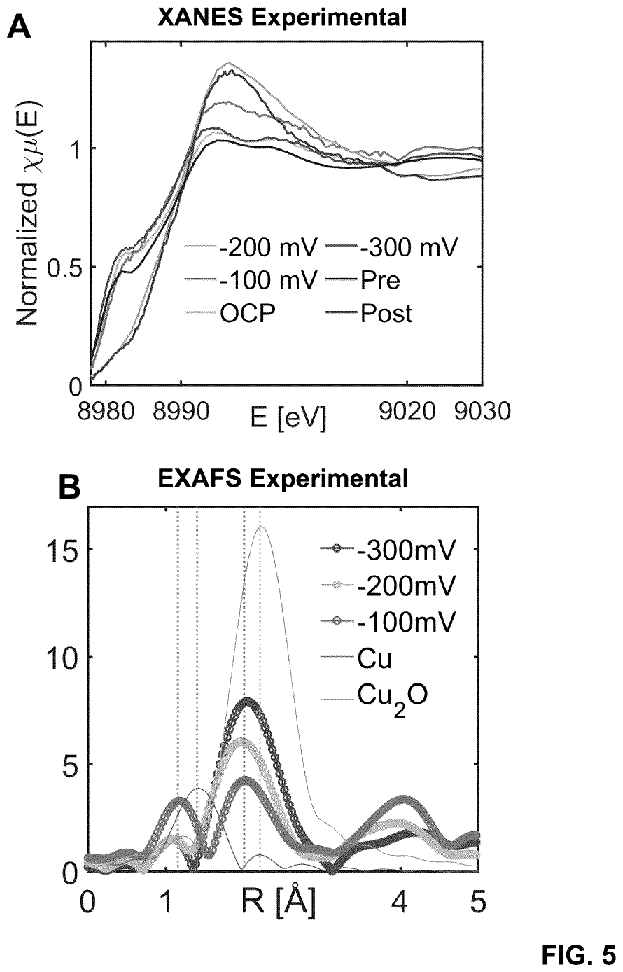

To investigate the nature of the active species, we devised an in situ XAS experiment to monitor the chemical nature of the CuO cluster composite catalysts. Following a previously reported procedure, we prepared a thin catalyst layer (~2 μm thick) of Cu—NCB on a carbon-sputtered Kapton® foil to minimize mass transport effects and limit delamination under operation [24,25,26]. Then, using an in-house developed in situ spectroelectrochemical cell which is based on the design of Binninger et al. [27], and that allows measurements in grazing incidence geometries, the transient nature of the CuO clusters was studied as a function of the potential under equivalent CO2RR conditions. Similar to the as-synthesized Cu—NCB catalyst, the catalyst at open circuit potential is fully oxidized, i.e., Cu(II) (FIG. 5A). Upon applying a cathodic potential of −100 mV vs RHE, the XANES spectra indicates the formation of a Cu2O phase. After further reduction to −200 mV, the Cu20 phase starts to disappear and the metallic phase appears. At-300 mV vs RHE, a complete reduction of the Cu(I) to Cu(0) can be observed. Further, a good agreement between the experimental results and the simulated XANES spectra of the relevant Cu oxide clusters and their metallic (FCC) counterparts can be observed (FIG. 5B). Finally, we exclude the presence of BCC crystal structures reported previously, by means of simulation [28]. For reasons of clarity, we show only a subset of the simulated XANES spectra of the particles. To investigate the atomic structure of the catalyst, we observed the pseudo-radial distribution function of the EXAFS spectra in the −100 and −300 mV vs RHE range (FIG. 5B). Indeed, a scattering event in the first coordination shell associated with the Cu20 phase could be observed up to −200 mV vs RHE. However, at-300 mV vs RHE, this feature is completely absent. Instead, a Cu—Cu scattering event can be discerned of metallic Cu. Fitting of the Cu coordination shell estimates a Cu coordination number of 7.3±3.3 [29]. We translate that into an average particle size of 1.2 nm [30,31] which is in excellent agreement with the as-synthesized CuO clusters. Further, we determine that the coordination bond has shortened by 0.10 Å with respect to the bulk, which is typically observed in clusters [32,33]. We can, thereby, conclude that the active species is indeed a metallic Cu cluster of an average atomicity of ~100 atoms, which agrees with the expected atomicity based on DMA and STEM-HAADF and was identified as promising through our computational method. Further, we observe the catalyst used for the synchrotron experiments post catalysis using STEM and confirm that it retained small particle size of ~1 nm, further corroborating the stability of the catalyst.

Finally, out of curiosity, we investigated the oxidation state of Cu clusters GDL catalyst composites after catalysis. Interestingly, the XAS spectra showed that the clusters had partially retained their metallic state even after exposure to air and independently of the support, i.e., Cu—Cu CNs for NCB- and GO-supported Cu clusters are 6.2±1.4 and 7.4±3.6, respectively. Again, the consistently small particle size of the clusters after reaction could be confirmed with STEM. This confirms the earlier reported oxidation resistance of metallic Cu cluster [34], and can be invoked to explain the catalysts stability.

### Conclusions

We have developed a scalable production and immobilization method of bimetallic Cu-based clusters of sizes <150 atoms. We show that such composite materials have unique catalytic properties and show high selectivity towards acetaldehyde (>90%) in the electrochemical conversion of CO₂. We show that our catalysts retain their in situ formed metallic nature post catalysis, and demonstrate that this feature offers resistance against potential cycling. We propose our catalyst production method as a platform technology that may offer researchers an entirely new class of catalyst to screen for activity in various electrochemical reaction such as water splitting, oxygen evolution, nitrogen reduction etc.

### Note S1. Experimental Part Related to Support Synthesis

As catalyst support, a selection of materials was chosen based on their activity in the CO2RR, overall conductivity, wettability, high-surface area, diverse heteroatom functionalities, scalability and overall economics from inhouse developed [1] as well as the literature inspired syntheses (FIG. 6) [2,3, 4,5,6]. In brief, the materials produced which were N-edge functionalized (FIG. 6A, B) were synthesized by mixing graphene nanoplatelets (Graphene Supermarket AO-4, 1 g) or multiwalled carbon nanotubes (PlasmaChem Gmbh, 1 g) with urea (Sigma Aldrich >99%, 3 g) and ball milled at 500 rpm for 48 hr at 20:1 ball (ZrO2) to reactant mass ratio under nitrogen atmosphere [5,6]. The products were washed and collected in i-PrOH reaching a concentration of 30 mg mL-1. The N-doped carbon black based material was synthesized via a protocol adapted from Yang et al. (FIG. 6C) [4]. In brief, Vulcan carbon black (FuelCellStore, 900 mg) was oxidized by means of mixing with an aqueous HNO3 solution (Sigma Aldrich ≥65%, 30 mL) and heated to 80° C. whilst stirring under reflux for 3 hrs. The oxidized carbon black was collected with 50 ml of water and washed until neutral pH ~6.8 was reached. The washed product was dried overnight under vacuum of which 150 mg was mixed with urea in a mortar (Sigma Aldrich >99%, 1.5 g). The mixture was placed in a ceramic boat and heated to 800° C. in 80 min, kept for 60 min at 800° C. and then cooled naturally to r.t. all under Ar atmosphere. The 500 mg of NCB—NP were washed and collected with i-PrOH reaching a concentration of 30 mg mL-1. Graphene oxide nanoparticles were produced according to a previously reported synthesis (FIG. 6D) [1].

### Note S2. Experimental Part Related to Cluster Production

In order to achieve a scalable synthesis of metal oxide clusters of controllable size, composition and (surface) loading, we investigated the production of metal oxide clusters via spark ablation, in which two metal electrodes of arbitrary composition are ablated via a spark generated plasma (>5000 K, Ar) to produce clusters in the aerosol [7,8,9,10,11]. Traditionally, spark ablation has been used to produce nanoparticles of a single element in the size range 5-20 nm (i.e. C, Ag, Pd, Zr, and Nb) [7,8]. More recently, multicomponent materials have been produced as well including immiscible mixtures and high-entropy alloys on various substrates but all of sizes>5 nm [12,9,10]. On the other hand, spark ablation has also been used to produce atomically precise metal (oxide) clusters (<2 nm) but only of single element (Ag, and Au) and purely in the aerosol and more importantly, not at practically relevant production levels (~pg/hrs) [13,11]. In here, we have achieved a scalable synthesis of Cu(Ag) metal oxide clusters <2 nm with a 6-orders higher mass production rate (μg/hrs). To produce such clusters of well-defined size and composition, and especially at high production rates, a highly specific spark generator configuration was chosen that optimized a set of parameters to control 1) the size, 2) the production rate and finally 3) the composition (FIG. 7).

To this end, FIG. 7 discloses (A) Faraday cup used to collect either negatively or positively charged clusters from the aerosol. The measured current (via an electrometer) allows to determine the number of ions hitting the cup per unit of time giving a measure of the ablation rate (cluster production rate). (B) Deposition chamber allowing for a filter deposition in which the entire aerosol flow is passed through a substrate as well as an electrostatic deposition method [14] in which a bias is applied to a substrate and as such only clusters of opposite polarity are adhered to it. (C) Aerosol exhaust. (D) Positive electrode (grounded). (E) Spark chamber. (F) Carrier gas (Ar) flow inlet. Direction of flow is from (E) to (B). (G) Negative electrode. (H) Pin-to-hole configuration of the electrode set-up of the spark ablator showing two Cu electrodes. Exchanging the pin or negative electrode for Ag allows for the production of bimetallic clusters. (I) Picture of the spark in operation. (J) Resistance-inductance-capacitance (RLC) electrical circuit, in which I denote the power supply. C denote(s) the capacitor(s), D denotes the one-way gate preventing excess current from passing through the grounded electrode, R denotes the resistor, L denotes the inductor needed to store potential energy via the magnetic field needed for the oscillatory nature of the spark. The spark is indicated by the damped exponential. (K) Oscillometer read-out of the spark showing a ~100 ns time constant of the frequency of the spark. The dampened exponential originates from the oscillating nature of the spark between the grounded and negative electrode.

### Note S2.1 Controlling the Cluster Size

The first objective, was to reduce the cluster size, which can be estimated based on Eq. 1:

$$D \approx {( \frac{3 β {V}_{eff} \dot{m}}{ρπ {Q}^{2}} )}^{1 / 3} \qquad ( 1 )$$

in which Q carrier gas flow rate in this case Ar [m3 s-1], Veff the effective volume in the spark chamber [m3], β the coalescence kernel [m3 s-1], which is rate at which two clusters coalesce, m the mass production rate [kg s-1] and p the density of the material ablated [kg m-3][15,16,9]. Therefore, three parameters needed to be optimized: 1) the Veff should be kept at a minimum, 2) the flow rate should be maximized and, finally, 3) the mass production rate should be minimized. To keep the effective volume as small as possible, we opted for a dual-mixed flow geometry using two inlets (FIG. 7A-G) and a pin-to-hole configuration (FIG. 7H) [17]. Further, we chose a gas flow rate of a factor of 2.5 higher with respect to a conventional nanoparticle spark generated synthesis (~6 nm Au) [15], effectively reducing the cluster size by a factor ~2. And lastly, we reduced the ablation rate, which is given by Eq. 2:

$$\dot{m} = Δ mf \approx {E}_{s} cf \qquad ( 2 )$$

in which Δm denotes the change in the electrode mass or ablated mass [kg] and f the repetition frequency of the spark [s-1], which roughly equates to the product of the energy per spark (Es) and c, a material dependent constant [kg J-1], by reducing the energy per spark (FIG. 7I). The Es, can be determined via Eq. 3:

$${E}_{s} = \frac{1}{2} {CU}^{2} \qquad ( 3 )$$

in which U denotes the breakdown-voltage [V] and C the capacitance [F] (FIG. 7J). By bringing the energy per spark down by an order of magnitude (1 nF), the cluster size should be reduced further by an estimated factor of ~2.2, effectively pushing the cluster size in to the cluster regime (~1 nm).

### Note S2.2 Optimizing the Ablation Rate

The second objective, was to enhance the production rate. Therefore, we maximized the spark repetition frequency to ~10 MHz by enhancing the charging current of the capacitor banks whilst maintaining a stable spark and preventing continuous plasma formation, which would destroy the size distribution as the well-defined nature of the clusters is a direct consequence of the pulsating nature of the spark (1 mA, FIG. 7K) [18]. Further, as the ratio between positively and negatively charged clusters differs in the cluster regime as well as their most frequently observed size [11], we investigated the effect of charge as well. FIG. 8 shows the effect of capacitance and cluster charge on both the cluster size and production rate for a Cu—Cu electrode configuration (i.e. FIG. 7H).

FIG. 8 illustrates how the voltage scan of the DMA is converted to a cluster size. The current measured by the electrometer is converted to a number concentration and thus the production rate (min losses). (A) The Cu oxide positively charged cluster size distribution with an average size of ~2.1 nm, a 7 105 s-1 production rate, at 0.4 KV spark discharge voltage, 1 mA charging current, 25 lpm aerosol gas flow and 20 nF capacitance. (B) The Cu oxide size distribution of negatively charged clusters with the average size of 1.6 nm and double the production rate at 1 nF capacitance but all other parameters kept the same (1.4 106 s-1).

### Note S2.3 Controlling the Cluster Composition

The third and final objective was to control the cluster composition by mixing in a second element. This can be achieved simply by switching out either the pin or the hole electrode for one of a different element (in this case Ag) [10]. Since the negatively charged electrode will have the highest relative ablation rate due to its attraction of the Ar+ ions existing in the plasma resulting in rapid ion bombardment [19], and we need a majority Cu for a good electrochemical performance, we opted to swop this electrode. FIG. 9 shows the size distribution with a Cu-pin, Ag-hole configuration.

### Note S3. Experimental Part Related to Electrostatic Precipitation Deposition.

In order to accurately deposit the metal oxide clusters on a substrate with a well-defined spot size to control the loading/dispersion on various substrates, we opted for the use of electrostatic precipitation [14]. Since metal oxide clusters carry for the large part a charge, they are well suited to be extracted from the aerosol using an applied bias. Therefore, we placed a TEM grid coated with support material orthogonal to the cluster beam (to minimize diffusion deposition) in the deposition chamber indicated in FIG. 7B. By applying a bias of (+/−) 60 V, all the clusters of opposite polarity could thereby be deposited on to the TEM grid by concentrating the cluster beam into a spot size equal to the TEM grid diameter. An optimized loading of 1.0 mg cm-2 MWCNTs, 0.27 mg cm-2 NG-NPs, 0.13 mg cm-2 NCB—, 0.050 mg cm-2 GO-NPs support was used for uniform sub-monolayer coating of the TEM grid (FIG. 6). The cluster spot size can be determined via Eq. 4:

$${r}_{spot} = \sqrt{\frac{Q}{π {V}_{d}}} \qquad ( 4 )$$

in which Q is the aerosol flow rate [m3 s-1] and Vd is the cluster velocity [m s-1], which can be estimated based on the cluster mobility (measured via the DMA) and the electric field applied. The projected 2D coverage of such an electrostatic precipitation deposition can then be estimated via Eq. 5:

$$coverage = \frac{{N}_{p} 4 π {r}_{p}^{2} {t}_{d}}{4 π {r}_{spot}^{2}} \qquad ( 5 )$$

in which Np denotes the cluster production rate [s-1], rp the cluster radius [m], and td the deposition tine [s]. For the electrostatic precipitation experiments, we report coverage in the form of partial monolayers as determined for a 2D projection on a flat surface. The actual coverage is factors smaller due to the added depth-profile of the 3D surface.

### Note S4. Experimental Part Related to Cluster Immobilization.

Since the clusters produced have >70% of their atoms at the surface, which are highly undercoordinated, they are extremely reactive and agglomerate and sinter easily. Therefore, cluster immobilization is no mean task. Here, we have studied the stability of (bi)metal oxide clusters on various carbonaceous supports: N-doped carbon black NPs (NCBNPs), graphene oxide NPs (GONPs), N-edge functionalized graphite NPs (NGNPs), and finally N-edge functionalized multiwalled carbon nanotubes (NMWCNTs). The synthesis of these substrates is described elsewhere. Here we report the cluster immobilization and stabilization via the electrostatic precipitation deposition study, described in Note S3, instead. We observed a deposition equivalent of 0.5 ML of CuO and CuAgO clusters in 2D projection with BF-TEM on all four supports (FIG. 10). For NCB, GO and NG, coated with CuO, no apparent clusters could be observed (FIG. 10A, C-D), which is a direct result of the low thickness contrast and low density of CuO. Instead, for the NMWCNTs-based sample, cluster agglomeration had occurred as clusters >20 nm could be distinguished (FIG. 10B). Interestingly, for the CuAgO clusters, a similar effect could be discerned as here larger clusters could be observed likewise (FIG. 10F). Contrarily, cluster agglomerates were absent for the NCB, NG, and GO coated materials with clusters <2 nm clearly visible (FIG. 10E, G-H).

In particular, FIG. 10 (A-D) depict NGNPs and NMWCNTs (produced mechanochemically) and NCBNPs and GONPs (produced chemically) coated with CuO clusters, respectively. No apparent clusters can be observed with BF-TEM other than in (B). This is due to the small cluster size, low relative density of CuO (6.31 g cm-3) and therefore low contrast in bright-field mode. Instead, in (B), cluster agglomeration had occurred resulting in the observed cluster size >20 nm. (E-H) NGNPs, NMWCNTs, NCBNPs, and GONPs coated with CuAgO clusters, respectively. Clusters <2 nm could clearly be observed for NCB, NG and GO based supports and indicated by the light-grey circles. However, the cluster size distribution for the NG-NPs indicated some form of sintering as the mean size shifted from ~1.5 to 2.1±0.6 nm (>2 nm cluster indicated by dark-grey circle). Further, for the NMWCNTs, cluster agglomerates >20 nm could be observed similar to the CuO coated system confirming the high surface mobility on carbon nanotubes (dark-grey circles, respectively).

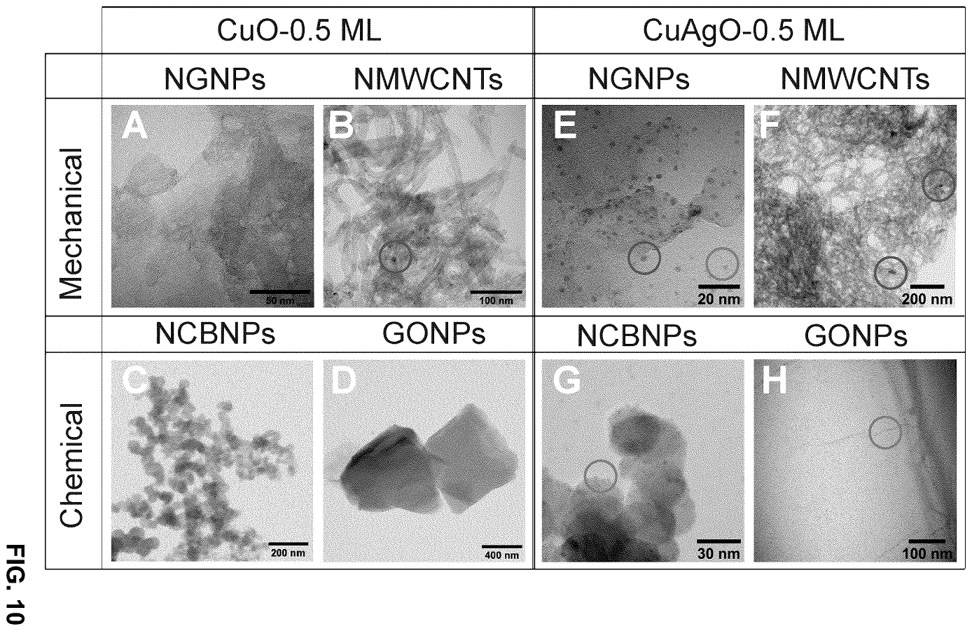

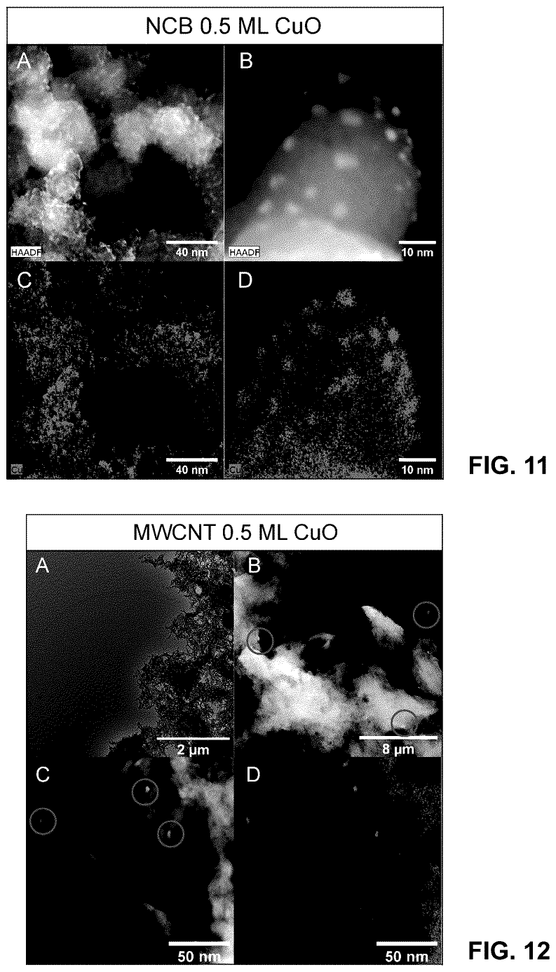

To further investigate the nature of the clusters (or the absence thereof) deposited on the various supports as well as their apparent agglomeration when deposited on NMWONTs, we conducted a STEM-HAADF/EDXS study. Here, we selected one unstable material, MWONT, and a stable one, NCB, and investigated both the CuO as well as CuAgO functionalization more thoroughly. FIG. 11 shows the outcome of CuO deposition on NCB. Indeed, a homogenous distribution of Cu clusters ~1.5 nm can be observed at the cluster surface comparing well with the measured size prior to deposition.

In particular, FIG. 11 depicts in (A-B) STEM-HAADF image at 0.45 and 1.25 MX magnification, respectively, showing a homogeneous distribution of higher contrasting clusters at the amorphous carbon substrate surface. The average cluster size of 1.5±0.5 nm compares well to the 1.6 nm determined by the DMA prior to deposition. (C-D) STEM-EDXS Cu elemental map of the images depicted in (A-B) confirming the Cu nature of the clusters.

Instead, for the mass equivalent CuO deposition on the MWCNTs, larger agglomerates >10 nm are directly visible in the STEM-HAADF image (FIG. 12). STEM-EDXS further confirms the Cu nature of the clusters.

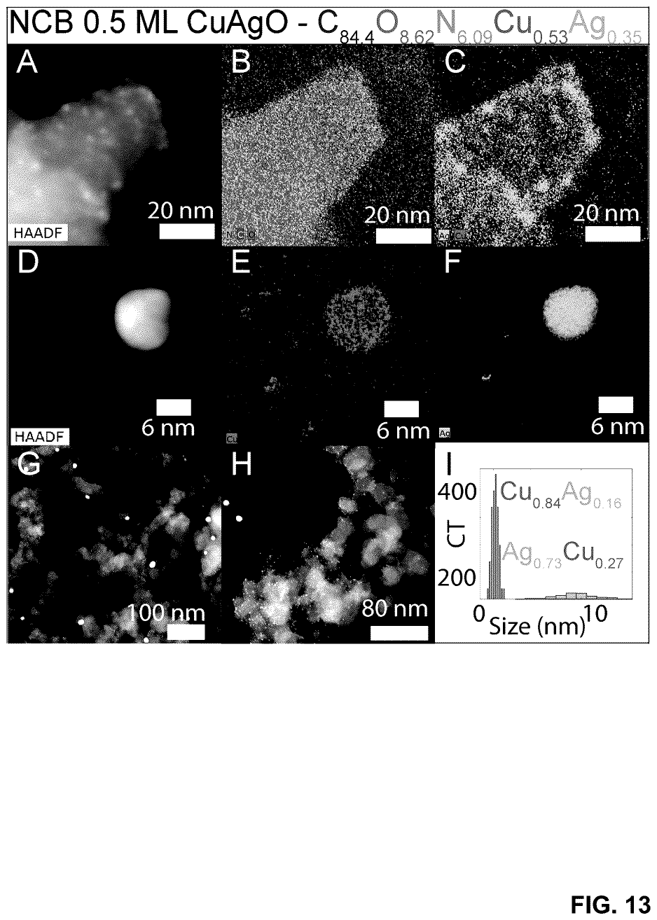

In particular, FIG. 12 depicts in (A) BF-TEM image of the substrate. (B) STEM-HAADF image of the coated substrate with >10 nm agglomerates visible indicated by the dark-grey circles. (C) STEM-HAADF image with clearly identifiable agglomerates. (D) STEM-EDXS elemental map of the image in (C) showing the Cu nature of the agglomerates. FIG. 13 shows the outcome of CuAgO deposition on NCB. The average cluster size determined with STEM-HAADF of 1.4±0.33 nm overlays well with the DMA determined ~1.5 nm (FIG. 13A). Therefore, we can conclude that the clusters produced by the spark have been successfully deposited without agglomeration. The high N-content in the NCB samples as well as the high surface area (average C—NP size ~50 nm) facilitate immobilization and stabilization of the clusters (FIG. 13B). STEM-EDXS puts the composition of the CuAgO clusters at Cu0.42Ag0.0800.5 (FIG. 12C). Further, a second cluster mode could be detected that was rich in Ag (FIG. 13D-F). However, its relative abundance was about two orders smaller and could therefore be neglected in the electrochemical performance considerations (FIG. 13G-F).

In particular, FIG. 13 depicts the TEM grid used was of Au to minimize interference. The composition offered in the title was determined by STEM-EDXS analysis. Note that the grid contains C as well. (A) STEM-HAADF image of the CuAgO clusters with average size of 1.4±0.33 nm. The measured size distribution compares well to the one measured via the DMA at 1.5 nm. (B) STEM-EDXS elemental map of the HAADF image in (A) showing a homogeneous mixture of N, C, O, in light-grey, black, and dark-grey, respectively. The N doping is as high as 6 at. %. (C) STEM-EDXS elemental map of the HAADF image in (A) of Cu and Ag in orange and turquois, respectively. Determined Cu:Ag ratio ~5:1. (D) STEM-HAADF image of large 9±1.9 nm cluster. (E) STEM-EDXS elemental map of the HAADF image in (D) showing Cu in dark-grey. (F) STEM-EDXS elemental map of the HAADF image in (D) showing Ag in light-grey. Determined Cu:Ag ratio: ~1:2.7. This cluster represents the second mode that is being produced at the 0.6 kV, 2.5 mA, and 15 lpm spark generator settings. (G) STEM-HAADF low-magnification image showing the relative abundance of the Ag rich cluster. (H) STEM-HAADF image showing the high relative abundance of the CuAgO clusters. (I) Quantification of the relative abundance of both cluster modes by observing a 630×630 nm area. Nearly 2-order larger abundance of CuAgO clusters vs Ag-rich NP. Average Cu:Ag composition calculated considering both relative abundance and cluster mass is 2.1:1, which compares well to the composition determined via XPS (see FIG. 21, Table S1).

FIG. 14 shows the outcome of CuAgO deposition on MWCNTs. Similar to what could be observed in BF-mode, STEM-HAADF pointed towards various agglomerates >20 nm (FIG. 14A,C). STEM-EDXS suggested Ag-species as the most mobile as most agglomerates where rich in Ag (FIG. 14B, D). Cu instead, showed stronger interaction with the support and remained relatively well dispersed, similar to what had been observed for CuO clusters. Finally, as a control experiment, we acquired a STEM-EDX spectrum confirming the absence of both Cu and Ag in the uncoated MWCNTs (FIG. 14E, F).

In particular, FIG. 14 shows in (A) STEM-HAADF image of agglomerate >20 nm. (B) STEM-EDXS elemental map of the image in (A) with Cu in dark-grey and Ag in light-grey. The cluster composition is given in the inset. (C) STEM-HAADF image of >2 nm clusters. (D) STEM-EDXS elemental map of the image in (C), which shows the high Ag content in the clusters. (E) STEM-HAADF image of uncoated MWCNTs. (F) STEM-EDX spectrum of the image in (E) showing the absence of both Cu and Ag prior to deposition.

An attempt was made to explain the weaker bonding of the clusters to the MWCNTs by investigating the work function of the supports arguing that stronger bonding should occur for the support with the lowest binding energy (FIG. 15). Interestingly, the secondary electron cut-offs (SECO) of the support materials, which is equivalent to the work function, could not explain the trend. Following the work function, bonding to the MWCNTs should be second best to NCB supported clusters.

Instead, we explain the agglomeration of the CuO/CuAgO clusters on the MWCNT substrate by their poor adhesion. The MWCNTs produced in this study, consist of rolled-up graphene nanosheets with possible amine, imines and amides, bond at their tips. The majority of the structure, however, is highly-crystalline, graphene (FIG. 16). Dietsche et al. showed that in order to stabilize Ag13 clusters on highly-ordered graphite, defects introduced by sputtering were necessary [20]. Further, both Cu and Ag are fully oxidized as determined by XPS (FIG. 21). And Ag clusters ~5 nm on (110) TiO2 have shown to undergo Ostwald ripening at room temperature when exposed to 02 as determined by STM proposing a potential growth pathway [21]. It was argued that Ag20 was the relevant species to undergo surface diffusion due to its higher mobility than its metallic counterpart.

This explains the larger Ag-rich agglomerates observed for the CuAgO MWCNTs coated materials vs the CuO coated ones. Upon the failure of Ag20 to find a stable ligation site, Ag20 diffuses rapidly over the surface and agglomerates. Instead, the Cu oxides bond relatively well to the surface and stays better dispersed. Nevertheless, for their high relative instability, we have excluded MWCNTs for any further consideration. Likewise, due the shift in cluster size distribution of roughly 33% larger of the CuAgO clusters on NG-NP support, we have excluded them as well.

### Note S5. Experimental Part Related to Cluster Composite Electrode Production.

In order to test the metal oxide clusters in the electrochemical CO2 reduction reaction, it is adamant that the cluster carbonaceous support composite will be scaled. Further, for potential flow and membrane assembled electrode cell configurations, the use of a gas diffusion layer support is highly advantageous. Further, to ensure homogeneous cluster coverage and good exposure to the electrolyte, cluster deposition via filtration in which the aerosol gas is directly flowed through a porous support is optimal. Therefore, we designed a Toray TGP-H-60 carbon paper-based gas diffusion electrode with a carbonaceous support catalyst layer air brushed on top (FIG. 17).

Ink was existed of 3:1 isopropanol:H2O in case of the NCB—, NG-NPs based inks and pure H2O for the GO-NPs based ink to prevent flocculation. The carbon paper was heated to 80, and 100° C., respectively to facilitate solvent evaporation. All inks were sonicated for 30 min prior to spraying.

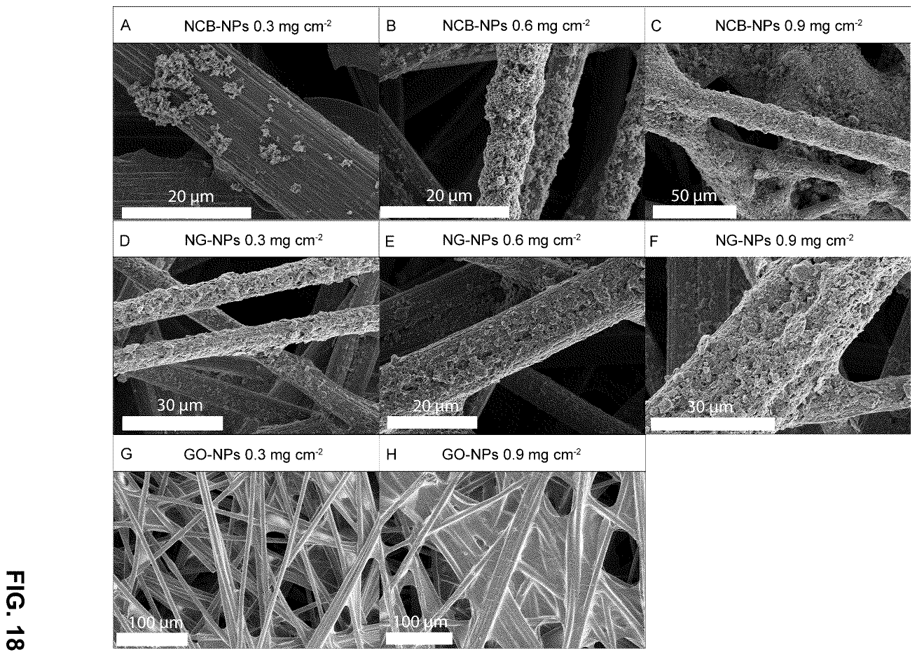

In order to achieve homogeneous coverage of the carbonaceous heteroatom doped support NPs on the carbon paper, a loading study was performed at different mass loadings for the GO-, NG-, and NCB-NPs based catalyst support inks at 1 mg mL-1 (FIG. 18).

Optimal loading was achieved at 0.3 mg cm-2 for the GO-NPs, and 0.6 mg cm-2 for the NCB—, NG-NPs-based composites in that pore blockage was prevented whilst maintaining good coverage allowing for facile aerosol filtration and electrolyte penetration. All cluster immobilization experiments were performed at the optimized catalyst support loading.

### Note S6. Experimental Part Related to Cluster Characterization Using XPS.

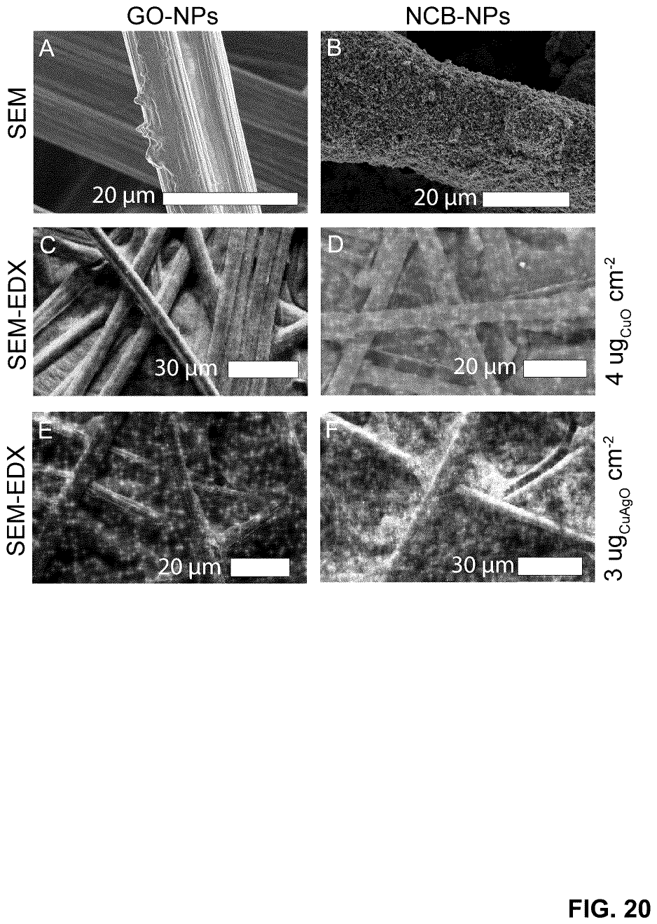

To investigate the oxidation state of both Cu and Ag in the bimetallic clusters excluding the influence of the support we deposited an equivalent amount of CuAg oxide clusters as indicated in FIG. 20 on pure carbon paper and performed XPS (FIG. 21). To determine the oxidation state after deposition, we performed XPS measurements on the composite 2 hrs (directly) after production (FIG. 21A-D) and after 7 days (FIG. 21E-H). Fitting of the Cu 2p and Cu LMM Auger spectrum suggested the presence of both CuO as well as Cu(OH)2 with the CuO the majority species at no less than 65 at. %. Determination of the Auger parameter for Ag based on the MNN Auger spectrum of Ag indicated Ag2O as the produced species. The high relative presence of —OH species in Cu suggest the oxidation of the clusters had already happened prior to deposition meaning in the aerosol. This can be understood from the following. In air, ~21% is 02 and ~78% N2. This, leaves <1% for H2O. Instead, in Ar, the relative ratio between O2 and H2O is ~1:1, explaining the relatively high OH content in the clusters.

FIG. 21 depicts in (A) Cu 2p spectrum of the CuAg oxide clusters. Fitting of the 2p spectrum suggests a combination of both CuO (933 eV) and Cu(OH)2 (935 eV) species, with the relative composition of CuO between 65-75 at. % and 25-35 at. % for Cu(OH)2. (B) Ag 3d spectrum showing no loss feature. From the 3d spectrum alone, it is not possible to determine the oxidation state of Ag. (C) Cu LMM Auger spectrum showing a combination of the Ag3p3 peak and the Cu LMM Auger peak. Position of the Cu Auger peak estimated at 917 eV through a fit. (D) Ag Auger spectrum showing the two MNN Ag peaks. The peak position MN1 at 356 eV used to determine the Auger parameter. Auger parameter of Ag of 724, which is much lower than metallic Ag proving the oxidized state of Ag after deposition. (E) Cu 2p spectrum of the CuAg oxide clusters 7 days after production. (F) Ag 3d spectrum 7 days after production showing again no loss feature. (G) Cu LMM Auger spectrum again showing the presence of the Ag3p3 peak. (H) Ag MNN Auger spectrum with the Auger parameter estimated at 718 eV confirming the oxidized state of Ag.

TABLE S1
Composition of the CuAgO clusters as deposited on
pure carbon paper (FIG. 21) containing two modes of
clusters: clusters of ~1.5 nm and clusters of ~9 nm
(FIG. 14). XPS surface composition and the weighted
STEM-EDX composition (Cu84Ag16 and Ag73Cu27, 132:1)
shows matching results with <5% error showing the
extreme conformity of the cluster beam produced
with the spark.

| CuAgO clusters | CuAg composition |
|---|---|
| 4 μg cm−2 | |
| XPS | Cu78Ag32 |
| STEM-EDX | Cu75Ag35 |

FIG. 22 depicts in (A-B) the O 1 s and N 1 s scan of the GO support, (C-D) the O 1 s and N 1 s scan of the NCB support, (E-F) the O 1 s and N 1 s scan of the MWCNT support and (G-H) the O 1 s and N 1 s scan of the NGNP support.

TABLE S2
Relative ratio of the surface composition of N/O/C species
of the support as determined by XPS analysis as performed
in FIG. 22. O 1s, N 1s and C 1s sensitivity factor
takes as 0.66, 0.42 and 0.25, respectively.

| | Peak Area | | | Peak ratio | |
|---|---|---|---|---|---|
| Name | C 1s | N 1s | O 1s | O 1s/C 1s | N 1s/C 1s |
| GO | 34221 | 4274 | 43949 | 0.486 | 0.0743 |
| NCB | 34415 | 1815 | 11260 | 0.124 | 0.0314 |
| MWCNT | 43790 | 277 | 2772 | 0.024 | 0.00038 |
| NGNP | 33586 | 2941 | 11072 | 0.125 | 0.0521 |

### Note S7. Evaluation of the Electrochemical Performance in the CO2RR

### Note S7.1 Cathode Preparation.

Conical pieces of Toray TGP-60r carbon paper coated with 0.6 or 0.3 mg cm-2 of NCB or GO respectively and functionbalized with ~4 μg cm-2 Cu(—Ag) clusters were cut out with a geometrical surface area of 0.5 cm². Finally, 20 μL of 0.83 wt % Nafion dispersed in iso-propanol were added as binder.

### Note S7.2 Electrochemical Measurements.

The electrodes were evaluated in a commercial gas-tight H-cell from Gaoss Union using constant potential mode controlled by a potentiostat (Autolab PGSTAT302N). All measurements were carried out at in 0.1 M KHCO3, which fungated as both catholyte and electrolyte (25 mL per chamber). Chamber were kept separate by means of a cation exchange (Nafion) membrane. Prior to electrochemical testing, the electrolyte was saturated with CO₂ by bubbling at 25 ml-min-1 for at least 15 min. Also, during any measurement, CO2 was bubbled through the catholyte continuously to ensure sufficient CO2 supply during the measurement. A Pt wire was used as counter electrode for the oxygen reduction reaction. An Ag/AgCl electrode was used as reference. All measurements were carried out at-1.1 V vs RHE. The value of the potential versus Ag/AgCl was converted to the scale of the reversible hydrogen electrode (RHE) using the equation: E (versus RHE)=E (versus Ag/AgCl (3 M KCl)+0.21 V+0.059*pH. The potential was mathematically compensated for the ohmic resistance that was determined by the electrochemical impedance spectroscopy (EIS). The FEs and currents were repeatedly measured on three individual electrodes for each material evaluated.

### Note S7.3 Quantification of the Gaseous Products.

Gas products were analysed online (10 min interval) using a gas chromatography (GC, SRI Instrument 8610C) with the auto-sampling loop (1 ml) connected to CO2 off-gas of the H-cell catholyte chamber. H2 was analysed using thermal conductive detector (TCD) and CO, CH4, and C2H4 were analysed using flame ionization detector (FID) with a methanizer.

### Note S7.4 Quantification of the Liquid Products Using NMR.

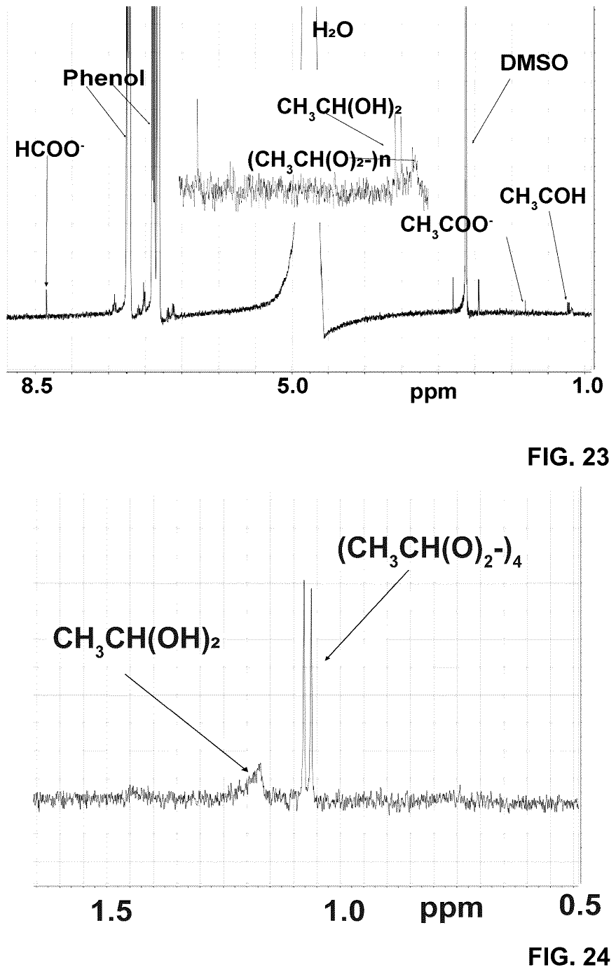

Quantification of the liquid products was achieved according to a previously reported method and a derivation of the Kuhl et al method [22,23]. In brief, the liquid products of all electrodes were quantified using nuclear magnetic resonance (NMR, Bruker 400 MHz AVIII HD). FIG. 23 shows ta typical 1D 1H NMR spectrum obtained for a standard solution containing typical liquid products from the CO2RR and the internal standards (phenol and DMSO) as indicated by the arrows. The peak area ratio of a given product to that of the internal standard, as obtained by peak fitting using MestReNova software, was used to determine the concentration of the products. Identical NMR acquisition parameters were used for all measurements. In addition, the water peak was suppressed using the solvent suppression function. The acquisition time of d1 was 5 s and the number of scans was 260. Products with peaks with chemicals shifts than larger water (>5 ppm) were quantified using phenol, all others with DMSO.

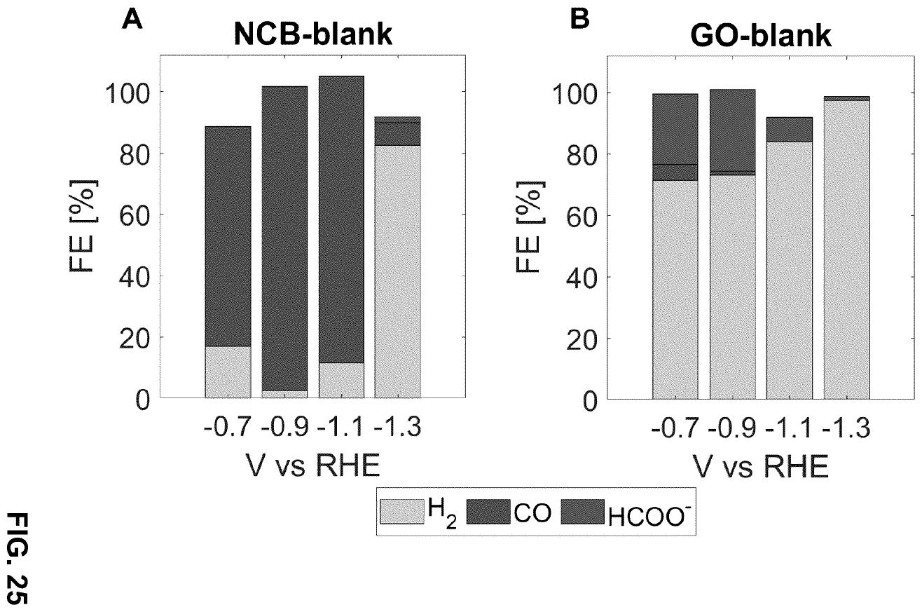

As follows from FIG. 23, the catholyte contains three CO2RR products: formate, acetate and acetaldehyde. The acetaldehyde exist a hydrated form and a less soluble aggregate i.e. metaldehyde resulting in peak broadening and shift to lower ppm values. Any multimer of acetaldehyde forms chemically and is base catalyzed. See FIG. 24 for a typical NMR spectrum of metaldehyde.

### Note S7.5 Calculation of the Faradaic Efficiency.

The faradaic efficiency (FE) was calculated for gas and liquid products, using

$$FE = \frac{{nFC}_{i} vP}{jRT}$$

$$and$$

$$FE = \frac{{nFC}_{i} V}{Q} .$$

respectively, where n is the number of transferred electrons to produce one molecule of product i, F is the faradaic constant, Ci is the concentration of the product as determined by GC or NMR, v is the flow rate of CO2, P and T are the pressure (101325 Pa) and temperature (22° C.) of the gas sampled by the GC sample loop, respectively, j is the total current when sampling, R is the gas constant, V is the volume of the electrolyte, and Q is the total charge transferred to produce the target product.

### Note S7.6 Determination of the Support Activity in CO2RR.

All measurements depicted in FIGS. 25 and 26 were performed in CO2 saturated 0.1 M KHCO3. The reaction was let to equilibrate for 10 min before the first sampling of the gas products was performed. An average over 30 min has been reported. Several washing steps with HNO3 was performed to remove trace metal species from the supports.

TABLE S3
Faradaic efficiencies of Cu-NCB per potential and product.

| | H2 | CO | CH3CHO | CH3COO— | HCOO— |
|---|---|---|---|---|---|
| Cu_NCB_0.5 V | 16.09 | 0.00 | 66.43 | 9.50 | 2.50 |
| Cu_NCB_0.6 V | 46.50 | 0.00 | 42.53 | 4.50 | 3.08 |
| Cu_NCB_0.7 V | 30.49 | 11.49 | 46.44 | 10.78 | 2.15 |
| Cu_NCB_0.8 V | 64.60 | 9.17 | 20.51 | 1.88 | 2.46 |
| Cu_NCB_0.9 V | 7.41 | 75.75 | 21.83 | 1.49 | 0.79 |
| Cu_NCB_1.1 V | 35.18 | 46.02 | 8.94 | 1.56 | 2.00 |
| Cu_NCB_0.5 | 16.09 | 0.00 | 20.27 | 1.96 | 2.50 |
| V_STD | | | | | |
| Cu_NCB_0.6 | 11.42 | 0.00 | 21.54 | 1.95 | 2.87 |
| V_STD | | | | | |
| Cu_NCB_0.7 | 21.38 | 16.25 | 19.86 | 4.43 | 1.58 |
| V_STD | | | | | |
| Cu_NCB_0.8 | 12.80 | 1.98 | 4.30 | 0.21 | 0.82 |
| V_STD | | | | | |

TABLE S4
Faradaic efficiencies of Cu-GO per potential and product.

| | H2 | CO | CH3CHO | CH3COO— | HCOO— |
|---|---|---|---|---|---|
| Cu_GO_0.5 V | 0.00 | 0.00 | 92.55 | 9.18 | 0.00 |
| Cu_GO_0.6 V | 56.02 | 0.00 | 31.84 | 5.08 | 1.69 |
| Cu_GO_0.7 V | 27.98 | 0.00 | 48.46 | 5.34 | 5.98 |
| Cu_GO_0.8 V | 82.60 | 0.00 | 19.57 | 2.81 | 3.75 |
| Cu_GO_0.9 V | 60.46 | 1.03 | 33.89 | 2.35 | 3.74 |
| Cu_GO_1.1 V | 88.58 | 2.50 | 3.20 | 0.52 | 2.61 |
| Cu_GO_0.5 | 0.00 | 0.00 | 1.87 | 0.02 | 0.00 |
| V_STD | | | | | |
| Cu_GO_0.6 | 2.12 | 0.00 | 1.16 | 1.85 | 0.60 |
| V_STD | | | | | |
| Cu_GO_0.7 | 18.34 | 0.00 | 26.81 | 3.47 | 2.76 |
| V_STD | | | | | |

TABLE S5
Faradaic efficiencies of Cu—Ag-NCB per potential and product.

| | H2 | CO | CH3CHO | CH3COO— | HCOO— |
|---|---|---|---|---|---|
| CuAg_NCB_0.5 V | 0.00 | 0.00 | 88.42 | 11.34 | 0.83 |
| CuAg_NCB_0.6 V | 0.00 | 0.00 | 83.45 | 18.25 | 2.85 |
| CuAg_NCB_0.7 V | 15.98 | 54.36 | 29.26 | 4.32 | 3.04 |
| CuAg_NCB_0.8 V | 36.32 | 39.58 | 15.06 | 1.92 | 5.44 |
| CuAg_NCB_0.9 V | 19.28 | 71.17 | 11.34 | 2.00 | 1.14 |
| CuAg_NCB_1.1 V | 39.06 | 49.72 | 0.00 | 1.21 | 8.99 |
| CuAg_NCB_0.5 | 0.00 | 0.00 | 0.97 | 0.40 | 0.83 |
| V_STD | | | | | |
| CuAg_NCB_0.6 | 0.00 | 0.00 | 2.66 | 3.99 | 0.81 |
| V_STD | | | | | |
| CuAg_NCB_0.7 | 0.91 | 1.12 | 3.16 | 0.09 | 0.44 |
| V_STD | | | | | |

TABLE S6
Faradaic efficiencies of Cu—Ag-GO per potential and product.

| | H2 | CO | CH3CHO | CH3COO— | HCOO— |
|---|---|---|---|---|---|
| CuAg_GO_0.5 V | 0.00 | 0.00 | 68.48 | 4.56 | 1.88 |
| CuAg_GO_0.6 V | 57.04 | 0.00 | 39.20 | 0.46 | 1.10 |
| CuAg_GO_0.7 V | 23.21 | 0.00 | 72.03 | 7.21 | 4.04 |
| CuAg_GO_0.8 V | 72.54 | 0.00 | 13.52 | 4.06 | 5.51 |
| CuAg_GO_0.9 V | 70.59 | 1.98 | 19.05 | 5.95 | 2.21 |
| CuAg_GO_1.1 V | 88.88 | 0.25 | 7.35 | 0.68 | 2.09 |
| CuAg_GO_0.5 | 0.00 | 0.00 | 4.95 | 0.80 | 1.62 |
| V_STD | | | | | |
| CuAg_GO_0.6 | 0.25 | 0.00 | 1.97 | 0.23 | 0.88 |
| V_STD | | | | | |
| CuAg_GO_0.7 | 3.75 | 0.00 | 4.40 | 7.84 | 2.30 |
| V_STD | | | | | |

### REFERENCES

1. Lee, D. C., Yang, H. N., Park, S. H. & Kim, W. J. Nafion/graphene oxide composite membranes for low humidifying polymer electrolyte membrane fuel cell. Journal of Membrane Science 452, 20-28 (2014).
2. Zhang, J., Xia, Z. & Dai, L. Carbon-based electrocatalysts for advanced energy conversion and storage. Science Advances 1, e1500564 (2015).
3. Duan, X. et al. Metal-Free Carbon Materials for CO2 Electrochemical Reduction. Advanced Materials 29, 1701784 (2017).
4. Yang, F. et al. Highly Efficient CO2 Electroreduction on ZnN4-based Single-Atom Catalyst. Angewandte Chemie International Edition 57, 12303-12307 (2018).
5. Fouda, A. N., Duraia, E. S. M. & Almaqwashi, A. A. Facile and scalable green synthesis of N-doped graphene/CNTs nanocomposites via ball milling. Ain Shams Engineering Journal 12, 1017-1024 (2021).
6. Jeon, I.-Y. et al. Direct nitrogen fixation at the edges of graphene nanoplatelets as efficient electrocatalysts for energy conversion. Sci Rep 3, 2260 (2013).
7. Schwyn, S., Garwin, E. & Schmidt-Ott, A. Aerosol generation by spark discharge. Journal of Aerosol Science 19, 639-642 (1988).
8. Peineke, C., Attoui, M. B. & Schmidt-Ott, A. Using a glowing wire generator for production of charged, uniformly sized nanoparticles at high concentrations. Journal of Aerosol Science 37, 1651-1661 (2006).
9. Feng, J., Ramlawi, N., Biskos, G. & Schmidt-Ott, A. Internally mixed nanoparticles from oscillatory spark ablation between electrodes of different materials. Aerosol Science and Technology 52, 505-514 (2018).
10. Feng, J. et al. Unconventional Alloys Confined in Nanoparticles: Building Blocks for New Matter. Matter 3, 1646-1663 (2020).
11. Maisser, A. et al. Characterization of atmospheric-pressure spark generated atomic silver and gold clusters by time-of-flight mass spectrometry. Journal of Aerosol Science 156, 105780 (2021).
12. Tabrizi, N. S., Xu, Q., van der Pers, N. M. & Schmidt-Ott, A. Generation of mixed metallic nanoparticles from immiscible metals by spark discharge. J Nanopart Res 12, 247-259 (2010).
13. Maisser, A., Barmpounis, K., Attoui, M. B., Biskos, G. & Schmidt-Ott, A. Atomic Cluster Generation with an Atmospheric Pressure Spark Discharge Generator. Aerosol Science and Technology 49, 886-894 (2015).
14. Preger, C., Overgaard, N. C., Messing, M. E. & Magnusson, M. H. Predicting the deposition spot radius and the nanoparticle concentration distribution in an electrostatic precipitator. Aerosol Science and Technology 54, 718-728 (2020).
15. Feng, J., Biskos, G. & Schmidt-Ott, A. Toward industrial scale synthesis of ultrapure singlet nanoparticles with controllable sizes in a continuous gas-phase process. Sci Rep 5, 15788 (2015).
16. Feng, J. et al. General Approach to the Evolution of Singlet Nanoparticles from a Rapidly Quenched Point Source. J. Phys. Chem. C 120, 621-630 (2016).
17. Megyeri, D., Kohut, A. & Geretovszky, Z. Effect of flow geometry on the nanoparticle output of a spark discharge generator. Journal of Aerosol Science 154, 105758 (2021).
18. Feng, J. Scalable Spark Ablation Synthesis of Nanoparticles: Fundamental Considerations and Application in Textile Nanofinishing. (Delft University of Technology, 2016). doi:10.4233/UUID:FB6C0122-587B-471D-8009-B52EF9B69B07.
19. Voloshko, A., Itina, T. E., Voloshko, A. & Itina, T. E. Nanoparticle Formation by Laser Ablation and by Spark Discharges—Properties, Mechanisms, and Control Possibilities. Nanoparticles Technology (IntechOpen, 2015). doi: 10.5772/61303.
20. Dietsche, R. et al. Comparison of electronic structures of mass-selected Ag clusters and thermally grown Ag islands on sputter-damaged graphite surfaces. Appl. Phys. A 90, 395-398 (2008).
21. Lai, X., St.Clair, T. P. & Wayne Goodman, D. Oxygen-induced morphological changes of Ag nanoclusters supported on TIO2(110). Faraday Disc. 114, 279-284 (1999).
22. Zhang, J., Luo, W. & Züttel, A. Crossover of liquid products from electrochemical CO2 reduction through gas diffusion electrode and anion exchange membrane. Journal of Catalysis 385, 140-145 (2020).
23. Kuhl, K. P., Cave, E. R., Abram, D. N. & Jaramillo, T. F. New insights into the electrochemical reduction of carbon dioxide on metallic copper surfaces. Energy Environ. Sci. 5, 7050-7059 (2012).
24. Povia, M. et al. Combining SAXS and XAS To Study the Operando Degradation of Carbon-Supported Pt-Nanoparticle Fuel Cell Catalysts. ACS Catal. 8, 7000-7015 (2018).
25. Diercks, J. S. et al. Spectroscopy vs. Electrochemistry: Catalyst Layer Thickness Effects on Operando/In Situ Measurements. Angewandte Chemie International Edition 62, e202216633 (2023).
26. Diklić, N. et al. Potential Pitfalls in the Operando XAS Study of Oxygen Evolution Electrocatalysts. ACS Energy Lett. 7, 1735-1740 (2022).
27. Binninger, T. et al. Electrochemical Flow-Cell Setup for In Situ X-ray Investigations. J. Electrochem. Soc. 163, H906 (2016).
28. L. Alfke, J. et al. BCC—Cu nanoparticles: from a transient to a stable allotrope by tuning size and reaction conditions. Physical Chemistry Chemical Physics 24, 24429-24438 (2022).
29. Ravel, B. & Newville, M. ATHENA, ARTEMIS, HEPHAESTUS: data analysis for X-ray absorption spectroscopy using IFEFFIT. J Synchrotron Rad 12, 537-541 (2005).
30. Frenkel, A. Solving the 3D structure of metal nanoparticles. Zeitschrift für Kristallographie—Crystalline Materials 222, 605-611 (2007).
31. Marinkovic, N. S., Sasaki, K. & Adzic, R. R. Determination of Single- and Multi-Component Nanoparticle Sizes by X-ray Absorption Spectroscopy. J. Electrochem. Soc. 165, J3222 (2018).
32. Yamazoe, S. et al. Hierarchy of bond stiffnesses within icosahedral-based gold clusters protected by thiolates. Nat Commun 7, 10414 (2016).
33. Apai, G., Hamilton, J. F., Stohr, J. & Thompson, A. Extended X-Ray—Absorption Fine Structure of Small Cu and Ni Clusters: Binding-Energy and Bond-Length Changes with Cluster Size. Phys. Rev. Lett. 43, 165-169 (1979).
34. Cook, A. W., Jones, Z. R., Wu, G., Scott, S. L. & Hayton, T. W. An Organometallic Cu20 Nanocluster: Synthesis, Characterization, Immobilization on Silica, and “Click” Chemistry. J. Am. Chem. Soc. 140, 394-400 (2018).

1. A conductive or semi-conductive cluster,
wherein the cluster essentially comprises or consists of a first-type material,
wherein the first-type material comprises a number of surface atoms that is at least half of a number of total atoms of the first-type material, and
wherein the cluster comprises less than 100 ppm of a second-type material being different from the first-type material.

2. The cluster according to claim 1, wherein the first-type material comprises core atoms, and wherein a ratio of the surface atoms to the core atoms is equal to or larger than 1.

3. The cluster according to claim 1, wherein the atoms of the first-type material.

4. A method of producing a cluster as claimed in claim 1, wherein the cluster is produced via spark ablation.

5. The method according to claim 4, wherein at least two electrodes are ablated during the spark ablation, and wherein at least one of:
the electrodes are the same or different from one another,
the electrodes in each case comprise or consist of at least one metal or
the electrodes in each case comprise or consist of at least one conductive or semi-conductive material.

6. The method according to claim 5, wherein the electrodes are ablated via a spark generated plasma that is generated from a carrier gas, and wherein at least one of:
the carrier gas is provided with a flow rate in the range of 10 lpm to 1000 lpm, and/or
the spark generated plasma has an energy per spark in the range of 5 μJ to 400 μJ, and/or
the spark generated plasma has a repetition frequency in the range of 500 Hz to 2 kHz.

7. (canceled)

8. An assembly comprising at least one of at least one cluster as claimed in claim 1, wherein the cluster is immobilized on a support.

9. The assembly as claimed in claim 8, wherein at least one of:
the support is at least one of carbonaceous, silicon-based, aluminium-based, cerium-based, oxide-based such as metal oxides, or combinations thereof, or
the support is functionalized.

10. The assembly as claimed in claim 8, wherein the assembly is configured as a catalyst for catalytic conversions or as an indicator for a sensor or as a conductor for an electronic circuit.

11. A method of producing an assembly as claimed in claim 8, the method comprising the steps of:
Producing the cluster; and
Immobilizing the cluster on the support.

12. The method as claimed in claim 11, wherein the cluster is immobilized on the support by at least one of deposition, filtration, diffusion, impaction, printing or combinations thereof.

13. The method according to claim 12, wherein the support is applied to a substrate,
wherein at least one of the substrate is porous or gas diffusive, and
wherein the cluster is immobilized on the support when the aerosol stream comprising the cluster flows through the substrate.

14. (canceled)

15. A method of catalytically converting at least one reactant, the method comprising the steps of:
Supplying at least one reactant;
Providing the assembly as claimed in claim 8; and
Contacting the at least one reactant with the catalyst to form a product from the at least one reactant by catalytic conversion.

16. The cluster according to claim 2, wherein at least one of the core atoms or the surface atoms at least one of transition metals, noble transition metals, or non-noble transition metals.

17. The cluster according to claim 3, wherein the atoms of the first-type material are at least one of transition metals, noble transition metals, or non-noble transition metals.

18. The method according to claim 5, wherein the electrodes in each case comprise or consist of at least one transition metal.

19. The method as claimed in claim 12, wherein at least one of:
the cluster is immobilized by at least one of electrostatic deposition or an electrostatic precipitation deposition,
the cluster is immobilized by a filter deposition, or
the cluster is transported into, and optionally through, the support by an aerosol stream comprising the cluster.
